(19) United States
(12) Patent Application Publication
(10) Pub. No.: US 2026/0300311 A1
(43) Pub. Date: Oct. 1, 2026

(54) Read And Write Augmentation For JSON Duality Views

(71) Applicant: Oracle International Corporation, Redwood Shores, CA (US)

(72) Inventors: Kishy Kumar, Santa Clara, CA (US); Tirthankar Lahiri, Palo Alto, CA (US); Juan R. Loaiza, Woodside, CA (US); Ajit Mylavarapu, Mountain View, CA (US); Ananth Raghavan, San Francisco, CA (US); Shashank Gugnani, Foster City, CA (US); Sukhada Shashank Pendse, Foster City, CA (US); Beda Christoph Hammerschmidt, Palo Alto, CA (US); Zhen Hua Liu, San Mateo, CA (US); Hui Joe Chang, San Jose, CA (US); Douglas James McMahon, Redwood City, CA (US)

(21) Appl. No.: 19/368,456

(22) Filed: Oct. 24, 2025

Related U.S. Application Data
(60) Provisional application No. 63/781,305, filed on Mar. 31, 2025.

(51) Int. Cl. G06F 16/25; G06F 16/21; G06F 16/22; G06F 16/28

(52) U.S. Cl. CPC G06F 16/252; G06F 16/211; G06F 16/2282; G06F 16/289

(57) ABSTRACT

Duality views are object views that return JSON duality view objects (“JDV objects”). JDV objects are virtual because they are not stored in a database as JSON objects. Rather, JDV objects are stored in normalized form across “base rows” of “base tables” and “base columns”. JDV objects are returned by a DBMS in response to database statements that request a JDV object from a JSON duality view; the JDV object that can be returned in this way may be referred to as belonging to or as being contained by and in the duality view. Importantly, through database statements that reference duality views, changes to the state of a JDV object may be specified at the level of a JDV object. A DBMS can execute a statement that assigns or sets a field value in a JDV object. The DBMS determines the particular underlying base tables, rows, and columns of the JDV object that need to be modified and then modifies those rows. The DBMS can execute a database statement that assigns a value to the base columns of those base rows. As a result, changes may be specified at the level of a JDV object (“object-directed change”) and may be specified to base columns of base rows of the JDV object (“table-directed change”). The ability to specify changes at these two levels may be referred to as data manipulation duality. The advancements to duality views described herein augment JSON objects with “computed” JSON fields, journal changes to JDV objects for replication and history tracking (“history tracking”) of changes, or validate changes made to JDV objects. The advancements are activated and controlled by, at least in part, issuing data definition language (“DDL”) commands that define directives that are associated with duality views. The computed fields of duality views are referred to as an augmented field. Augmentation directives for a duality view define one or more augmented fields for JDV objects belonging to the duality views and define how to compute field values of the augmented fields. The augmented fields and their respective field values are computed on the fly when, for example, generating JDV objects to return for database query statements that project JDV objects from duality views. Augmented fields may be computed from other JSON fields of a JDV object, including other augmented fields. Augmented fields may be generated by read augmentation or write augmentation. Augmented fields generated by read augmentation are similar to computed columns; these augmented fields are not stored in a base column of a base row. Write augmentation computes values for base columns, for example, default values. Notification directives define various ways of journaling changes to JDV objects. Notification directives may define the replication of changes to JDV objects or may specify tracking changes in a form that can be queried. Notification directives specify what level of detail to journal and what kind of changes trigger journaling. The level of detail to journal includes the entire JDV object or just the changed portions. A JDV object of a duality view changes when a base row changes, which may also be a base row for another JDV object belonging to the same duality view or a different duality view. In addition, the base row may have been changed in multiple ways: by a table-directed change directed to the base row, an object-directed change to the JDV object, or an object-directed to change another JDV object in the same or different duality views. A notification directive specifies which of these circumstances causes a change to the JDV object to be journaled. A validation directive for a duality view specifies criteria that must be met by field values of the JDV object belonging to a duality view. The validation directives are applied to a JDV object in a duality view when the JDV object is changed or read. Similar to notification directives, validation directives specify what kind of changes trigger validation. A database transaction may change multiple JDV objects in multiple duality views. Notification directives and validation directives may require generating multiple JDV objects, the base rows for which may be numerous and may be stored in multiple tables; some of the base rows may be changed by the database transaction, and many may not. The multiple JDV objects to generate should be generated in a manner that is transactionally consistent. DBMS mechanisms for transactional consistency rely on row-level semantics that are insufficient for assuring transactional consistency at the object level.

### FIELD OF THE INVENTION

The present disclosure relates to the storage and retrieval of JavaScript object notation (JSON) objects in a database management system (DBMS), including relational DBMSs (RDBMS) and DBMSs that store collections of tables or documents, such as JSON objects.

### RELATED APPLICATION

The present application is related to U.S. patent application Ser. No. 17/966,724, entitled “Natively Supporting JSON duality view in a Database Management System”, filed by Zhen Hua Liu, et al. on Oct. 14, 2022, having Attorney Docket No. 50277-5946, the entire contents of which are herein incorporated by reference, and referred to herein as the “Json Duality View application”.

The present application is related to United States Patent Application entitled. “Techniques for Comprehensively Supporting JSON Schema in a RDBMS”, filed by Zhen Hua Liu, et al., on Oct. 14, 2022, having Attorney Docket No. 50277-5882, the entire contents of which are herein incorporated by reference.

The present application claims priority to U.S. Provisional Patent Application No. 63/781,305, entitled Directives for JSON Duality Views, filed by Kishy Kumar, et al. on Mar. 31, 2025, the entire contents of which are incorporated herein by reference.

### BACKGROUND

JSON is a lightweight data specification language for formatting “JSON objects”. A JSON object comprises a collection of fields, each of which is a field name/value pair. A field name is, in effect, a tag name for a node in a JSON object. The name of the field is separated by a colon from the field's value.

RDBMS vendors and No-SQL vendors both support JSON functionality to varying degrees. RDBMS vendors, in particular, support JSON text storage in a varchar or character large object (CLOB) column and apply structured query language (SQL) and/or JSON operators over the JSON text, as specified by the SQL/JSON standard. A RDBMS may also include a native JSON data type. A column may be defined as a JSON data type, and dot notation may be used to refer to JSON fields within the column. JSON operators may operate on a column having a JSON data type.

Another important way RDBMS vendors support JSON functionality is to enable the generation of JSON objects through object views of relational data. Under the object view approach, data for an individual JSON object is stored and retrieved across multiple columns in one or more tables of a relational database. Each of the field values of the JSON objects may be stored individually in respective columns across multiple tables of a relational database. In effect, the values of a JSON object are stored in shredded/normalized form across multiple columns of one or more underlying tables.

The object view approach provides a duality for querying JSON object content. JSON object content may be accessed as JSON objects or as relational data. Through SQL commands, JSON object content may be accessed as tables having rows and columns. Through object views, JSON object content may be returned as JSON objects, with fields that include object fields and array fields. This duality extends to changing object content. RDBMSs provide the capability to process commands that specify changes to JSON objects at an object level.

However, RDBMSs that provide this duality do not provide certain powerful capabilities that are analogous to those provided for row-based relational data.

For example, an RDBMS provides the capability to define virtual columns, which do not hold values themselves but whose values are computed at runtime based on values in other columns. Specifically, the value of the virtual column for a given row is computed from other values in that row. No comparable capability is provided for JSON objects under the object approach.

As another example, RDBMs provide the capability to validate a change to a column in a row based on other column values of the row. There is no comparable capability to validate a JSON field in a JSON object based on other fields in the JSON objects under the object view approach.

As yet another example, RDBMs provide the ability to replicate, to other RDBMSs, database transactions that change rows in a manner that is transactionally consistent with database transactions. Under the object view approach, there is no comparable capability to replicate JSON objects stored in an RDBMS in a normalized form.

### BRIEF DESCRIPTION OF THE DRAWINGS

In the drawings:

FIG. 1 depicts a schema of base tables that are used to illustrate various techniques described herein

FIG. 2 depicts a DDL statement that defines a JSON duality view and a JDV object returned by the JSON duality view, according to an embodiment of the present invention.

FIG. 3 depicts a JDV object returned that belongs to a JSON duality view, according to an embodiment of the present invention.

FIG. 4 depicts an augmentation directive according to an embodiment of the present invention.

FIG. 5 depicts syntax for augmentation directives and inline augmentations according to an embodiment of the present invention.

FIGS. 6A and 6B show sections of the definition of JSON duality view having inline augmentations based on JSON path expressions, according to an embodiment of the present invention.

FIGS. 7A and 7B show sections of the definition of JSON duality view defining array augmented fields, according to an embodiment of the present invention.

FIG. 8 depicts an abridged version of a duality view that uses a single object subquery to define multiple inline augmented fields.

FIG. 9 depicts a procedure for object construction according to an embodiment of the present invention.

FIG. 10 depicts an illustrative view dependency table that includes dependency mappings that each map a database table to a duality view and an identifying path, according to an embodiment of the present invention.

FIG. 11 depicts a flow of operations performed for the affected object framework, according to an embodiment of the present invention.

FIG. 12 illustrates a transactional inconsistency that can arise when generating JDV objects to journal, according to an embodiment of the present invention.

FIG. 13 illustrates a transactional inconsistency that can arise because of latent inserts of a JDV object, according to an embodiment of the present invention

FIG. 14 illustrates an object serialization algorithm according to an embodiment of the present invention.

FIG. 15 depicts a DDL syntax for defining a notification directive according to an embodiment of the present invention.

FIG. 16 depicts a procedure performed by a DBMS for determining the object change operation of an affected object, according to an embodiment of the present invention.

FIG. 17 depicts a procedure for journaling affected objects of a database transaction to a replication log, according to an embodiment of the present invention.

FIG. 18 depicts a syntax for a notification directive used to define history tracking on JSON duality view, according to an embodiment of the present invention.

FIG. 19 depicts data blocks and a redo buffer used to illustrate how a database transaction is atomically committed, according to an embodiment of the present invention.

FIG. 20 depicts the commit of a database transaction, as augmented with commit patching, according to an embodiment of the present invention.

FIG. 21 depicts a commit SCN log, according to an embodiment of the present invention.

FIG. 22 depicts a partitioned table family for a transaction commit SCN and history tables, according to an embodiment of the present invention.

FIG. 23 depicts a procedure for active-partition succession, according to an embodiment of the present invention.

FIG. 24 depicts a syntax for DDL statements that are used to define validation directives according to an embodiment of the present invention.

FIG. 25 depicts a DDL statement defining a validation directive according to an embodiment of the present invention.

FIG. 26 depicts a DDL statement defining a validation directive according to an embodiment of the present invention.

FIG. 27 depicts the DDL statement used to define a validation directive that calls a user-defined validation function, according to an embodiment of the present invention.

FIG. 28 depicts a DDL statement defining the validation function referenced by a DDL statement, according to an embodiment of the present invention.

FIG. 29 depicts a procedure for performing validation directives having validation timing of BEFORE OBJECT and/or AFTER OBJECT, according to an embodiment of the present invention.

FIG. 30 depicts a procedure that can generate separate affected view-path lists during compile time under the affected object framework, according to an embodiment of the present invention.

FIG. 31 depicts a procedure for performing validation according to an embodiment of the present invention.

FIG. 32 depicts a procedure for modifying base rows of JDV objects that are inserts or updated by object directed changes, according to an embodiment.

FIG. 33 depicts a syntax for inline write augmentation and a portion of a DDL statement defining inline write augmentation, according to an embodiment of the present invention.

FIGS. 34A and 34B depict a portion of a DDL statements that include illustrative inline write augmentations, according to an embodiment of the present invention.

FIG. 35 depicts a computer system, according to an embodiment of the present invention.

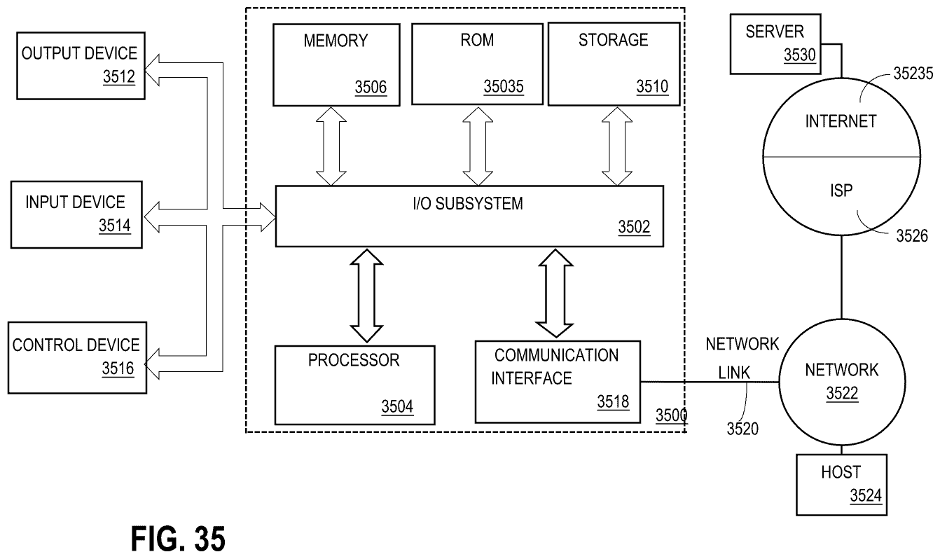

FIG. 36 depicts a software system, according to an embodiment of the present invention.

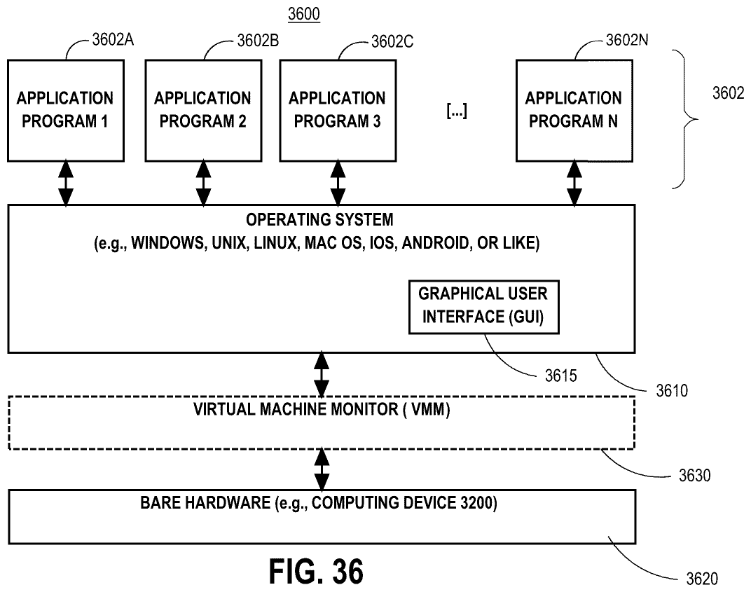

### DETAILED DESCRIPTION

In the following description, for the purposes of explanation, numerous specific details are set forth in order to provide a thorough understanding of the present invention. It will be apparent, however, that the present invention may be practiced without these specific details. In other instances, structures and devices are shown in block diagram form in order to avoid unnecessarily obscuring the present invention.

### OVERVIEW

Described herein are advancements to JSON duality views (“duality views”). Duality views are object views that return JSON duality view objects (“JDV objects”). JDV objects are virtual because they are not stored in a database as JSON objects. Rather, JDV objects are stored in normalized form across “base rows” of “base tables” and “base columns”. JDV objects are returned by a DBMS in response to database statements that request a JDV object from a JSON duality view; the JDV object that can be returned in this way may be referred to as belonging to or as being contained by and in the duality view.

Importantly, through database statements that reference duality views, changes to the state of a JDV object may be specified at the level of a JDV object. A DBMS can execute a statement that assigns or sets a field value in a JDV object. The DBMS determines the particular underlying base tables, rows, and columns of the JDV object that need to be modified and then modifies those rows. The DBMS can execute a database statement that assigns a value to the base columns of those base rows.

As a result, changes may be specified at the level of a JDV object (“object-directed change”) and may be specified to base columns of base rows of the JDV object (“table-directed change”). The ability to specify changes at these two levels may be referred to as data manipulation duality.

The advancements to duality views described herein augment JSON objects with “computed” JSON fields, journal changes to JDV objects for replication and history tracking (“history tracking”) of changes, or validate changes made to JDV objects. The advancements are activated and controlled by, at least in part, issuing data definition language (“DDL”) commands that define directives that are associated with duality views.

The computed fields of duality views are referred to as an augmented field. Augmentation directives for a duality view define one or more augmented fields for JDV objects belonging to the duality views and define how to compute field values of the augmented fields. The augmented fields and their respective field values are computed on the fly when, for example, generating JDV objects to return for database query statements that project JDV objects from duality views. Augmented fields may be computed from other JSON fields of a JDV object, including other augmented fields. Augmented fields may be generated by read augmentation or write augmentation. Augmented fields generated by read augmentation are similar to computed columns; these augmented fields are not stored in a base column of a base row. Write augmentation computes values for base columns, for example, default values.

Notification directives define various ways of journaling changes to JDV objects. Notification directives may define the replication of changes to JDV objects or may specify tracking changes in a form that can be queried. Notification directives specify what level of detail to journal and what kind of changes trigger journaling. The level of detail to journal includes the entire JDV object or just the changed portions. A JDV object of a duality view changes when a base row changes, which may also be a base row for another JDV object belonging to the same duality view or a different duality view. In addition, the base row may have been changed in multiple ways: by a table-directed change directed to the base row, an object-directed change to the JDV object, or an object-directed to change another JDV object in the same or different duality views. A notification directive specifies which of these circumstances causes a change to the JDV object to be journaled.

A validation directive for a duality view specifies criteria that must be met by field values of the JDV object belonging to a duality view. The validation directives are applied to a JDV object in a duality view when the JDV object is changed or read. Similar to notification directives, validation directives specify what kind of changes trigger validation.

A database transaction may change multiple JDV objects in multiple duality views. Notification directives and validation directives may require generating multiple JDV objects, the base rows for which may be numerous and may be stored in multiple tables; some of the base rows may be changed by the database transaction, and many may not. The multiple JDV objects to generate should be generated in a manner that is transactionally consistent. DBMS mechanisms for transactional consistency rely on row-level semantics that are insufficient for assuring transactional consistency at the object level. Described herein are novel complex mechanisms that provide transactional consistency at the object level.

### ILLUSTRATIVE RELATIONAL DATABASE FOR DUALITY VIEW

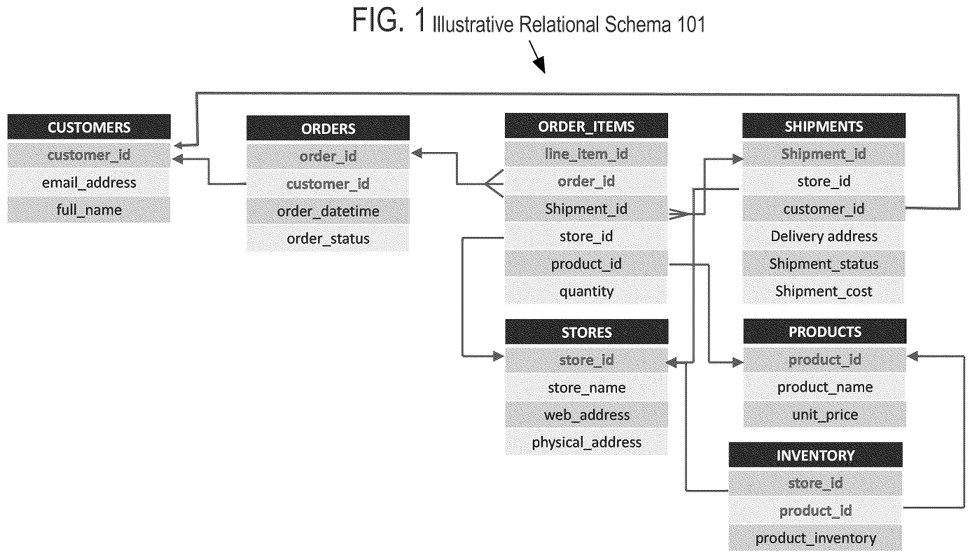

FIG. 1 is a diagram that depicts a schema of base tables that are used to illustrate various techniques described herein. The illustrative schema stores order information for ORDERS. Referring to FIG. 1, illustrative relational schema 101 includes tables ORDERS, ORDERS_ITEMS, CUSTOMERS, SHIPMENTS, and CUSTOMERS, among other tables. Also depicted in FIG. 1 are the primary key (PK) and foreign key (FK) relationships between these tables. For example, ORDERS.order_id in table ORDERS is a primary key, and ORDERS_ITEMS.order_id in table ORDERS_ITEMS is a foreign key that contains primary key values in primary key ORDERS.order_id. The direction of the line from ORDER_ITEMS.order_id to ORDERS.order_id denotes that the former key is a foreign key based on the latter primary key, which is ORDERS.order_id.

A JDV object comprises a “root” object that may comprise subobjects and/or arrays. A JSON duality view, in effect, maps the root object to a root table and, more particularly, maps the root object to a “root” query expression of the root table that projects the JDV object. The root query expression may be referred to as the duality view's main constructor query. Columns of the root table are mapped to scalar fields of the root object. A value held in a mapped column is the value for the scalar field. By mapping JSON fields to columns and tables in this way, JSON duality views define object view schemas.

For a subobject or array of an object view schema, the JSON duality view defines a respective subquery within the root query. The subquery is correlated to the root query based on a primary key and foreign key relationship. The subquery projects a JSON object or array from a base table. Columns of the base table are mapped to scalar fields of the subobject or array. A subobject or an array of an object view schema is referred to herein as an object field or array field.

A table or column mapped by a JSON duality view to fields of an object view schema defined by the JSON duality view is respectively referred to herein as a base table or a base column with respect to the JSON duality view, the object view schema, or a JDV object returned from the JSON duality view. A base table of a JSON duality view that is not the root table of a JSON duality view is referred to herein as a descendant base table with respect to the JSON duality view.

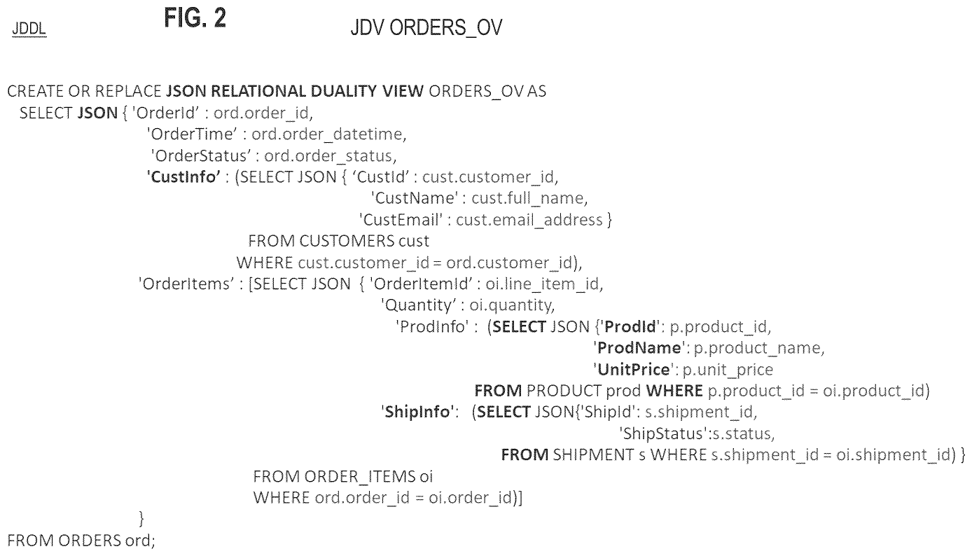

FIG. 2 depicts an illustrative JSON duality view ORDERS_OV defined by a DDL statement JDDL. The JSON duality view contains JDV objects representing orders. The root table for ORDERS_OV is ORDERS.

JDDL includes a root query expression that comprises an outer query expression and a subquery expression. The root query expression in JDDL projects the operator JSON{}. The root query expression includes a field mapping that maps base columns of the root table ORDERS to scalar fields of the root object. In particular, the root query expression maps the base columns ord.order_id, ord.order_datetime, and ord.order_status in the root table ORDERS to JSON fields OrderId, OrderTime, and OrderStatus, respectively. (Note: “ord” is an alias for table ORDERS.) By mapping fields in this way, the root query expression defines an object view schema that includes these scalar fields at the root object level of the object view schema.

The JDDL also defines an object field CustInfo using a correlated subquery-based expression that projects a JSON object using the operator JSON{}. The correlation is based on the join predicate in the WHERE clause in the correlated subquery expression. The join predicate references the correlated column ord.customer_id in the join predicate condition cust.customer_id=ord.customer_id. By referencing the FK cust.customer_id and PK ord.customer_id in the join predicate condition, ORDERS_OV defines an FK:PK relationship between CUSTOMERS and ORDERS with respect to ORDERS_OV. The FK:PK relationship is 1:1 (one-to-one).

The correlated subquery expression maps JSON fields of the object field CustInfo to base columns of base table CUSTOMERS. Custid, CustName, and CustEmail are mapped to JSON fields cust.customer_id, cust.full_name, and cust.email_address, respectively.

JDDL also defines an array field OrderItems, by defining a correlated subquery-based expression that projects a JSON array. The bracket “[]” construct denotes the JSON object operator projects each JSON object returned by correlated subquery as an element of the array field OrderItems. The correlation is based on the join predicate in the WHERE clause in the correlated subquery expression. The join predicate references the correlated column oi.order_id in the join predicate condition ord.order_id=oi.order_id. By including the FK ord.order_id and the PK oi.order_id in the join predicate condition of the correlated subquery, ORDERS_OV defines a PK:FK relationship between ORDERS and ORDER_ITEMS with respect to ORDERS_OV. A PF:FK relationship is 1:N (one-to-many).

The array field OrderItems includes fields OrderItemID and Quantity, which are mapped to base columns oi.line_item_id and oi.quantity, respectfully. In addition, the array field includes two object fields ProdInfo and ShipInfo, which define objects based on correlated subqueries. For object field ProdInfo, JSON field ProdId, ProdName, and UnitPrice are mapped to columns p.product, p.product_name, and p.unit_price, respectively. For object field ShipInfo, fields ShipId, and ShipStatus are mapped to columns s.shipment_id and s.status, respectively.

### ILLUSTRATIVE JDV OBJECT

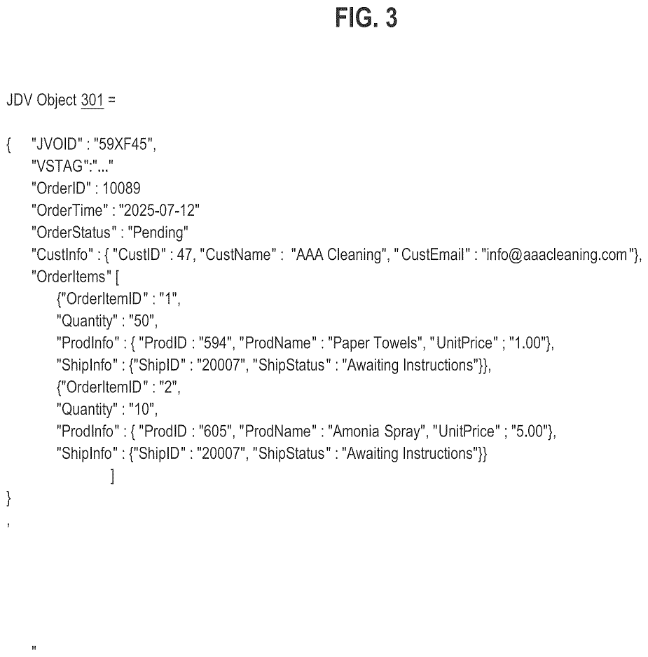

FIG. 3 depicts object 301, an example of a JDV object belonging to ORDERS_OV. Object 301 may be constructed and returned by a DBMS in response to being issued the following query JQA.
JQA =SELECT obj FROM ORDERS_OV
WHERE obj.order_id=“10089”

JDV object 301 includes fields OrderId, OrderTime, and OrderStatus and their respective values. When constructing JDV object 301, the field values were retrieved from a row in table ORDERS having order_id=10089. As indicated earlier, a row from which values of the field of a JDV object are retrieved or derived is referred to herein as a base row. OrderId, OrderTime, and OrderStatus are retrieved from columns in the base row, which are columns order_id, order_datetime, and order_status. Columns in a base row from which a value of a JSON field is retrieved or derived are referred to as base columns.

JDV object 301 also includes the object field CustInfo, which includes fields CustID, CustName, and CustEmail and their respective values. The base row for these fields is the row in table CUSTOMERS that is retrieved in effect by joining CUSTOMERS and ORDERS based on the FK:PK relationship between the tables ORDERS and CUSTOMERS as defined by ORDERS_OV.

Object 301 includes array field OrderItems, which includes multiple elements. Each element corresponds to a respective base row in table ORDERS_ITEMS. The base rows were retrieved in effect by joining ORDERS and ORDER_ITEMS based on the PK:FK relationship between these tables that is defined by ORDERS_OV. As the relationship is 1:N, multiple rows were joined. Each of these rows is a base row for an element in the array field OrderItems.

Each element also includes object fields ProdInfo and ShipInfo. Object field ProdInfo corresponds to a base row from table PRODUCT, from which the values for JSON fields ProdID, ProdName, and UnitPrice are retrieved. Object field ShipInfo corresponds to a base row from table SHIPMENT, from which the values for JSON fields ShipId and ShipStatus are retrieved.

As demonstrated above, a single JDV object may be constructed from columns stored in multiple base rows from multiple base tables. The multiple base rows are referred to herein as a base row set. A root query or any subquery therein that is defined by the JSON duality view may be referred to herein as a constructor query or a constructor subquery of the JSON duality view.

To generate a JDV object, a JDV construction query projecting the JDV object is issued against the JSON duality view containing the JDV object using its object ID in a filter predicate. JQA is an example of a JDV construction query. The JDV object returned by the JDV construction query is stored in an in-memory form, which may be in a character-based marked-up form according to JSON. A JDV object represented in this form is referred to as a materialized JDV object. A materialized form may also be stored in an in-memory serialized form or stored persistently in, for example, a LOB or CLOB column of a database table or in a file. To generate the materialized JDV object, a DBMS performs object construction as described below and then stores the JDV object in an in-memory form, which may then be stored persistently.

In addition, in-memory JDV objects may be generated during the execution of database statements that do not return the JDV object as a result of the database statement. Such in-memory JDV objects may be needed for database statement operations and directive application operations that require a materialized form of the JDV object, even though the JDV object is not returned as a result of the database statement, as shall be later described.

### DETERMINANT KEYS IN LIEU OF PRIMARY KEYS

Duality views have been described as specifying joins that use PK:FK and FK:PK relationships between base tables to define object fields and array fields. However, an embodiment of the present invention is not limited to using relationships that are based on a primary key to define an object field and/or array field. In an embodiment, an object field and an array field of a duality view may be defined based on joins that use a column that is a “determinant key”.

A primary key is an example of a determinant key. For a determinant key of a table, each row in the table stores or is assumed to store a value in the determinant key that is unique among the values stored in other rows of the table in the determinative key. Thus, a determinant key value should be contained in only one row of the table and may be referred to as being determinative of the row that contains the key value. A determinative key that is not a primary key is a column subject to a uniqueness constraint.

In fact, a database may define no constraint on a determinative key that requires that each determinative key value stored in any particular row be unique among the other determinant key values stored in the rows of the table. Applications, query statements, and duality views are designed and/or defined on the assumption that the key values of a determinant key are unique. A determinant key defined without such a constraint is referred to herein as a de facto determinant key. The uniqueness of determinant key values in a determinant key may be maintained externally to a DBMS by, for example, an application.

A foreign key may hold values in a primary key or, more generally, in a determinant key. If the determinant key is an ad hoc determinant key, the database does not constrain foreign key values of a foreign key to those in the determinant key. In the latter case, a foreign key contains or is assumed to contain only determinant key values in a determinant key of another table. Applications, query statements, and duality views are designed and/or defined on the assumption that the foreign key value of the foreign key is a determinative value in a respective determinant key in a table. Thus, while a pair of tables may have PK:FK or FK:PK relationships, more generally, a pair of tables may have a DK:FK (determinant key-foreign key) or a FK:DK relationship.

In an embodiment where a join between a parent and child table is used to define an object or an array field, a DBMS may require that the join use a FK:PK or PK:FK relationship defined by the DBMS. In another embodiment, a DBMS may not enforce this requirement for duality views. In this way, a FK:DK or DK:FK relationship may be exploited more generally to define duality views. DK:FK relationships may be used to define array fields, and FK:DK relationships may be used to define object fields.

### SYSTEM GENERATED FIELDS

Fields JDVOID and VSTAG are fields that a DBMS automatically generates for any JDV objects returned by a JSON duality view. An object view schema of a JSON duality view is referred to herein as including these fields. A JDV object ID may be used to identify a JDV object in a database statement. JDVOID stores a JDV object ID, which is a unique identifier generated by a DBMS for a JDV object to uniquely identify the JDV object among other JDV objects belonging to the JSON duality view or even JDV objects belonging to other JSON duality views. Copies of JDV objects are referred to herein as being the same if the respective JDV object IDs in the JDVOID field match. The copies, however, may be different versions with different content.

Field VSTAG is a version signature field that contains a version signature. A version signature is unique for each version of a particular JDV object. Version identifiers may be used to determine whether a previously retrieved JDV object has changed. If the version identifier of the previously retrieved JDV object returned by a JSON duality view does not match a version currently returned by the JSON duality view, then any underlying base attribute values have changed.

### AUGMENTATION

There are two general types of augmentation: read augmentation and write augmentation. As indicated earlier, read augmentation is analogous to computed fields in a relational database. Read augmentation adds an augmented JSON field to a JDV object when the JSON duality view object is constructed during execution of a database statement that accesses a JSON duality view. A field value is generated according to a function or an expression as described in further detail.

Write augmentation computes values for existing fields of an object when modifying a JDV object. The value is referred to herein as a write augmented value. A use example of write augmentation is to generate a default value for a field, which, in effect, becomes a default value for a respective base column of the field.

Fields augmented by read augmentation are referred to herein as read augmented field or augmented field. A field augmented by write augmentation is referred to as a write augmented field.

An augmented JDV object may be returned as the result of a database statement. For example, as the JDV object returned for database statement JQA. In addition, a JDV object may be computed as an intermediate result that is used during execution of that database statement; execution of the statement does not return the intermediate result as a result of the database statement.

A read augmentation may be an inline augmentation or a directive augmentation. Inline augmentations are embedded within a duality view definition. A DDL statement issued to define a JSON duality view may include an inline augmentation. A directive augmentation is a named database object separately defined in a database dictionary by issuing a DDL statement.

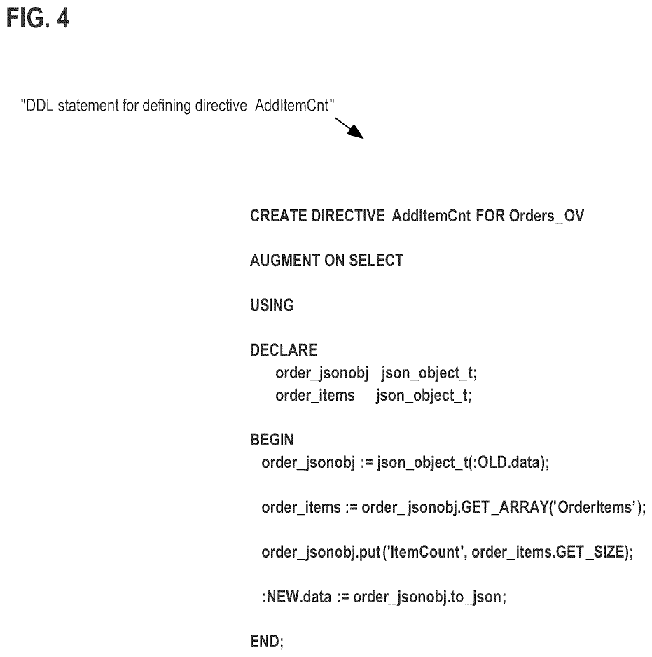

As an introduction to read augmentation, FIG. 4 depicts a DDL statement that defines a directive AddItemCnt for JSON duality view ORDERS_OV. The directive adds a field ItemCount to an ORDERS_OV object that represents the number of line items in an order. Directive AddItemCnt defines an implementation for an anonymous function that creates ItemCount in the ORDERS_OV object. Other features defined by the directive AddItem by the DDL statement shall be later described.

The implementation is, in effect, executed against a JDV object when the JDV object is constructed during the execution of a database statement that generates the JDV object. The implementation relies on the instantiate of in-memory copies of JDV objects, which may be referenced by variables within the implementation. The variables include:
:OLD.data—a reference to an unmodifiable in-memory version of the JDV object (“old JDV object”). The in-memory version is not modifiable by the implementation.
:NEW.data—a reference to an in-memory version of the JDV object (“new JDV object”) that is modifiable.

The DECLARE block declares variables order_jsonobj and orders_items as in-memory JSON objects. In the BEGIN block, order_jsonob is constructed as an instance of the old JDV object, and orders_items is constructed as an array OrderItems in the old JDV object.

The invocation of the put method on order_jsonobj adds the JSON field ItemCount to order_jsonob, setting the value to the number of items in the OrderItems array, which is returned by the object method orders_items. GET_SIZE.

Finally, :NEW.data is set to order_jsonobj, which generates the augmented JDV object as augmented with the ItemCount field.

### AUGMENTATION DIRECTIVE SYNTAX IN FEATURES

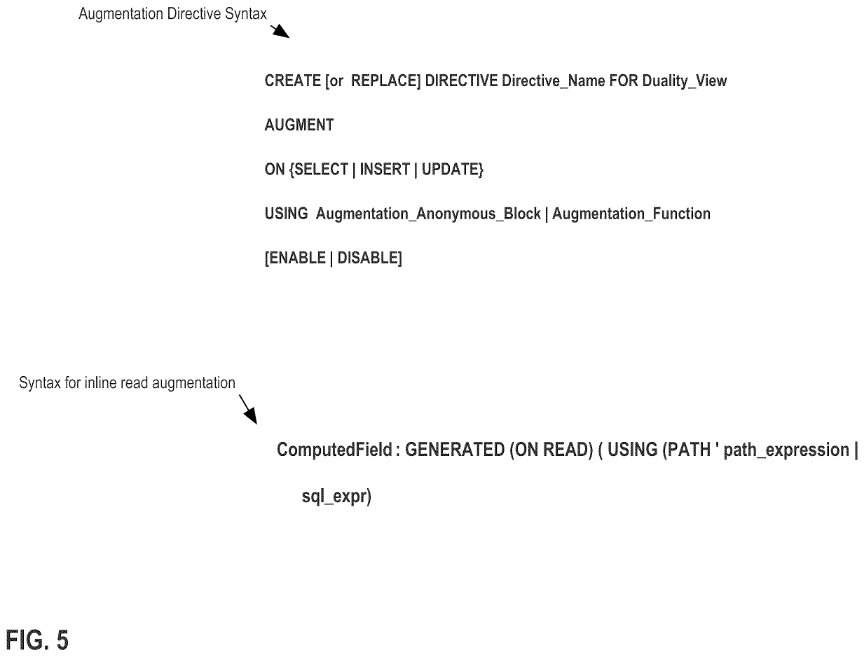

FIG. 5 depicts an augmentation directive syntax for a DDL statement that defines a read augmentation according to an embodiment of the present invention. A syntax for inline augmentations will be described later. Referring to the augmentation directive syntax, the augmentation directive syntax includes a DIRECTIVE clause that takes as an argument Directive_Name, the name for the augmentation to define. A DDL statement begins with either a CREATE or REPLACE keyword that specifies whether the name directive is being created or replaced by the properties and/or arguments specified in the DDL statement. The AUGMENT keyword specifies the directive is an augmentation directive.

The ON clause specifies for which type of database statement the directive is applied. According to an embodiment, one or more of SELECT, INSERT, and UPDATE types may be selected. SELECT is specified for read augmentations. INSERT and/or UPDATE are selected for write augmentation.

An augmentation directive may include an ENABLE or DISABLE keyword, which indicates whether the directive is active or not. When active, the directive is applied to the execution of database statements that construct augmented objects based on the JSON duality view. When not active, the directive is not applied. Other types of directives may include the ENABLE or DISABLE keyword and operate in a similar manner. Thus, with respect to other directives, the effect of these keywords will not be further discussed.

The USING clause defines the expression or function used for augmentation. A function may be an anonymous function or a named function to call that is defined by the DBMS. In the case of an anonymous function, the USING clause includes the argument Augmentation_Anonymous_Block, which is an anonymous function implementation, as illustrated by the directive AddItemCnt (see FIG. 4). Such a named or anonymous function is herein referred to as a directive function. The term expression includes function invocations.

### FACILITATING DESIGN AND IMPLEMENTATION OF DIRECTIVE FUNCTIONS

A goal of effecting a function implementation for a directive is to facilitate the ability to assess and foresee the effects and behavior of an implementation by simply examining the implementation. To this end, restrictions may be imposed on how the directive function for read augmentation may be implemented.

In an embodiment, an implementation should be deterministic. The same input should always result in the same behavior and output. The behavior and output should only depend on the state of the input and not a state external to the input. In addition, the directive function should change only local variables and not change any external state beyond the system-provided new JDV object. The directive should not assign any value to a local variable that is not a local variable of the implementation or the system-provided reference to the new JDV object. In an embodiment, an implementation may be non-deterministic and may change external state.

In addition, a JSON duality view may be annotated with augmented fields to describe the JDV object view schema as augmented by augmentation directives. The below-abridged depiction of ORDERS_OV illustrates such an augmented field annotation.
CREATE OR REPLACE JSON RELATIONAL DUALITY VIEW ORDERS_OV AS
   SELECT JSON { . . .
      ‘OrderItems’: [ . . . ]
      ‘ItemCount’: GENERATED[datatype]USING DIRECTIVE
      . . . } . . .
   FROM ORDERS ord . . . ;

The augmented field annotation references the augmented field followed by a GENERATED clause that includes the key phrase USING DIRECTIVE. The argument datatype argument is optional.

Alternatively, a DBMS may include augmented field annotations in utilities to output a JSON duality view definition. The inclusion of augmented fields may be an option for the utility. Augmented fields are part of the object view schema JDV objects belonging to a JSON duality view.

### INLINE AUGMENTATIONS

As mentioned earlier, inline augmentations are embedded within JSON duality view definition; inline augmentations are included in a DDL statement used to create or alter a view definition. Inline augmentation can be used for read augmentations or write augmentations. FIG. 5 depicts a syntax for DDL statements that define JSON duality views that include inline augmentations:

To define a read augmented field, the inline augmentation includes an argument ComputedField, which specifies the name of the augmented field, followed by a GENERATED clause. A similar syntax is used for inline write augmentations, which is described later.

The ON READ clause declares an inline read augmentation. An ON WRITE clause declares an inline write augmentation. A GENERATED clause without an ON READ or ON WRITE clause declares by default an inline read augmentation.

The inline read augmentation must define how to calculate the respective augmented field. The calculation is specified in the USING clause, and includes one of the following parameters.
path_expr preceded by the keyword PATH. Path_expr is a JSON path expression that evaluates to a value and which must refer either to an intrinsic field (a JSON field directly mapped to a base column) of the JSON duality view or to an already defined augmented field, as further described below.
sql_expr is an SQL expression that can be a base column of the JSON duality view or a subquery expression, as further explained below.

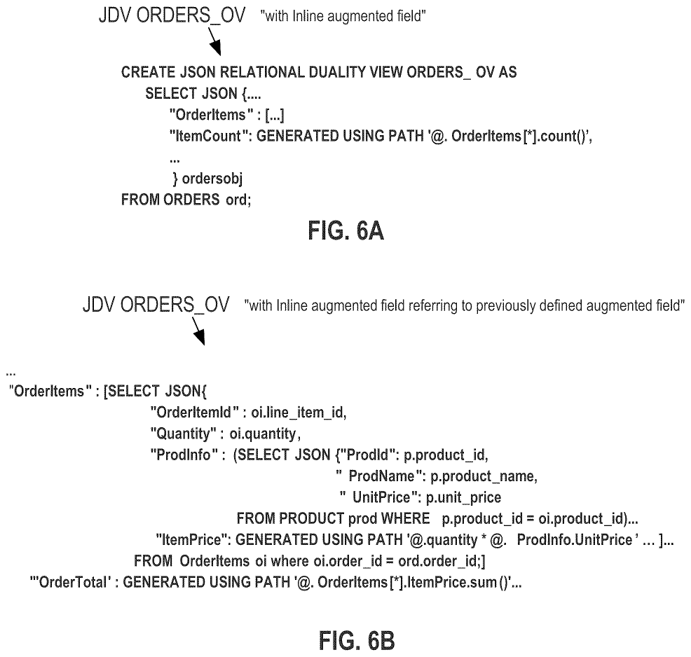

FIG. 6A is an abridged depiction of a version of ORDERS_OV that includes an inline augmentation based on a JSON path expression. The inline augmentation defines the augmented field ItemCount, which is a count of the number of order line items in an order. The path expression @.OrderItems[*].count() returns the number of elements in the array field OrderItems. JSON path expressions are described in Oracle Database, JSON Developers Guide, 22ai (F46733-03), the entire contents of which are incorporated herein by reference.

FIG. 6B is an abridged depiction of a version of ORDERS_OV that includes an inline augmentation defining an augmented field that refers to another augmented field. Specifically, the inline augmentation for ItemPrice is calculated according to the JSON path expression @.quantity*@.ProdInfo.UnitPrice. The JSON field ItemPrice is defined as a JSON field of the OrderItems array field.

OrderTotal is an inline augmentation defined by the path expression @.OrderItems[*].ItemPrice.sum(), which refers to the earlier defined ItemPrice augmented field. The path expression returns the sum of ItemPrice across the elements of the OrderItems array.

### SUBQUERIES THAT DEFINE AUGMENTED FIELDS

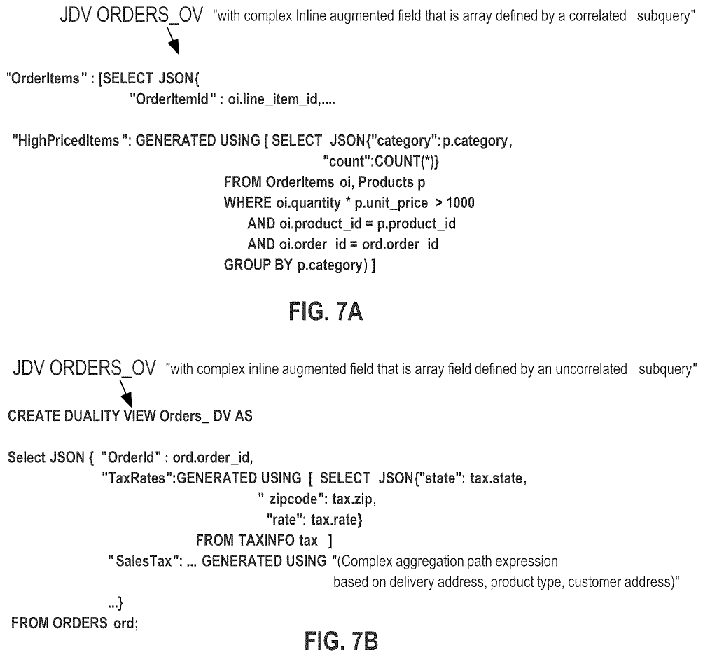

Subqueries may be used to define augmented object fields or array fields. FIG. 7A is an abridged depiction of a version of ORDERS_OV that includes a definition of an array augmented field HighPricedItems, which is defined by a correlated subquery. The subquery is correlated to the root level query of ORDERS_OV by the join predicate oi.order_id=ord.order_id. The array field HighPricedItems is an array that, for an order, includes a count for each product category of the high-priced items in the order, that is, having a price over 1000. Each element in the array includes the field category and count.

FIG. 7B also includes an augmented array field that is based on an uncorrelated subquery, a subquery without a correlation predicate. Referring to FIG. 7B, augmented array field TaxRates is an array field defined by an uncorrelated subquery of a table TAXINFO, aliased as “tax”. An element of TaxRates includes fields state, zipcode, and rate, the base columns of which are tax. state, tax, zip, tax. rate.

SalesTax is an augmented field that represents the total sales tax for an order. It is computed using a complex correlated aggregation, the details of which are not shown, based on delivery address, product quantity and type, and customer address.

The same subquery may be used to define multiple inline augmentation fields. During object construction, the subquery may, in effect, be executed once per JDV object to generate the multiple inline augmented fields for the JDV object.

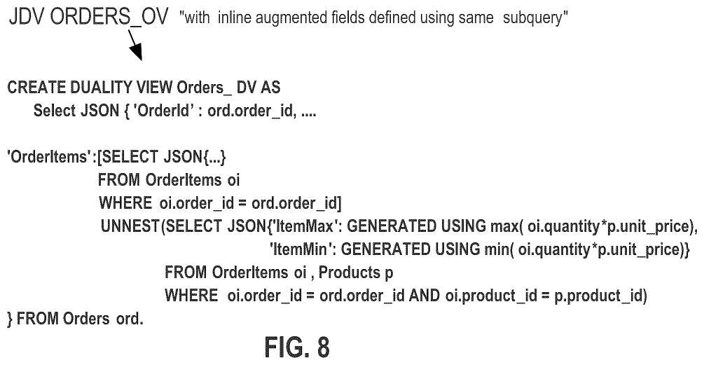

FIG. 8 depicts an abridged version of ORDERS_OV that uses a single object subquery to define multiple inline augmented fields. Referring to FIG. 8, fields ItemMax and ItemMin are defined using the same object constructor subquery. The UNNEST clause specifies that the fields mapped to a constructor subquery following the UNNEST clause are not fields of an embedded subobject.

### OBJECT CONSTRUCTION

Object construction refers to creating an in-memory JDV object that is populated with fields and field values according to the respective JSON duality view, inline augmentations therein, and an augmentation directive defined for the JSON duality view. Object construction is performed in many situations, as shall be described, such as during the execution of a JDV construction query.

During object construction, an object is initially populated with the intrinsic fields. An intrinsic field is a JSON field that is directly mapped to a base column by a JSON duality view. Directly mapped means the JSON duality view simply maps the JSON field to a base column without explicitly specifying an expression for computing the field value of the field (e.g., specifying a path expression, SQL expression, function invocation) that is based on the base column and/or another JSON field.

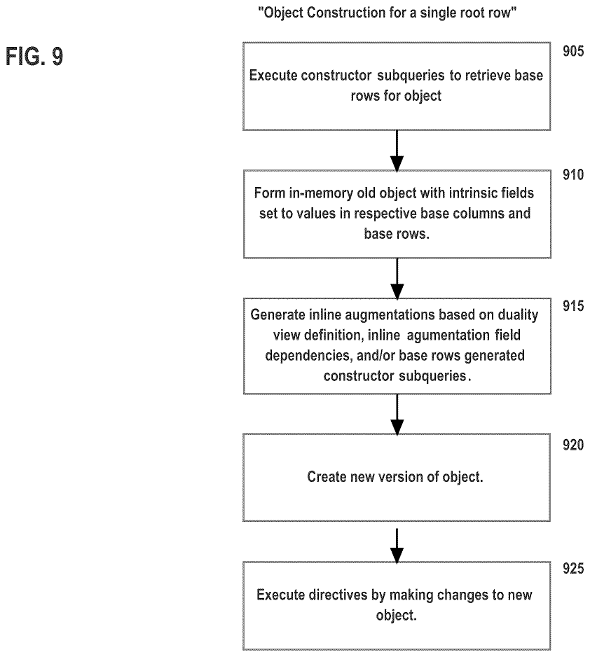

FIG. 9 depicts a procedure for object construction. In an embodiment, object construction is performed on a per root table row basis. Hence, the operations depicted in FIG. 9 are performed for a particular root table row. For example, a query execution plan for executing database statement JQA may first find through an index scan of an index on ORDERS.order_id of table ORDERS, the base row that stores the value “10089” in the order_id column. The root row is retrieved, and object construction begins by retrieving other base rows for the object, as further described.

Referring to FIG. 9, the constructor subqueries are executed to retrieve base rows for respective object fields and array fields. (905) The constructor subqueries are executed according to FK:DK or DK:FK relationships specified in the JSON duality view, except in the case of an uncorrelated constructor subquery.

Once the base rows have been retrieved, which include the root row from the root table and those retrieved from the execution of constructor subqueries, the in-memory old JDV object is created (910). The intrinsic fields of the old JDV object are populated with values from the respective base columns of the base rows.

Once the old JDV object with intrinsic field values is constructed, inline augmented fields are computed and added to the old JDV object. (915) The inline augmented fields are computed according to their respective definitions in the JSON duality view. The following are examples of how inline augmented fields are computed.

ItemCount (see FIG. 6A) The augmented field value is generated by evaluating the path expression @.OrderItems[*].count() against the old JDV object.

OrderTotal (see FIG. 6B) The augmented field is calculated according to the path expression @.OrderItems[*].ItemPrice.sum(), the calculation requiring values in ItemPrice in the array field OrderItems. Thus, the inline augmented field is dependent on the inline augmented field ItemPrice. In general, inline augmented fields are computed in an order that respects the dependency of other inline augmented fields. Accordingly, the ItemPrice field is computed first for each element in the array field OrderItems. Next, OrderTotal is computed by computing the path expression @.OrderItems[*].ItemPrice.sum() against the array field OrderItems.

HighPricedItems (See FIG. 7A) HighPricedItems is an augmented array field. The base rows for the array field have been generated by execution of the constructor subquery shown in the GENERATED clause. The base rows are used to generate the array field, one element for each base row generated by the constructor subquery.

Next, a new JDV object is created by setting it to the just-created and augmented old JDV object. (920) The old JDV object and new JDV object are now available for execution of the augmentation directives defined for the view. The old JDV object and new JDV object are accessible to a function implementation through variables OLD.data and NEW.data, respectively.

Next, the implementations of directive functions defined for the JSON duality view are executed. For example, the function implementation of the augmentation directive AddItemCnt is executed, adding the augmented field ItemCount. Specifically, ItemCount is added by invoking the put method of the in-memory new JDV object referenced in the implementation of the augmentation AddItemCnt.

For read augmentation, an output of object construction is the old and new JDV objects. Their use depends on the semantics of the database statement for which old and new JDV objects were generated. For example, for JQA, the new JDV object is returned as the result of the JQA. If executing a DML statement that changes a JDV object, changes specified are made to the new JDV object. The new JDV object, as changed, is compared to the old JDV object to determine the changed fields and then, in turn, to determine which base rows in which base table have been changed.

### UNDERLYING PRINCIPLES FOR NOTIFICATION AND VALIDATION DIRECTIVES

As mentioned before, notification directives and validation directives are applied to JDV objects when changed. A JDV object of a duality view changes when a base row changes, irrespective of how the row is changed. The base row may be a base row for other JDV objects belonging to the same duality view or a different duality view. In addition, the base row may have been changed in different ways: by a table-directed change directed to the base row, an object-directed change to the JDV object, or an object-directed change to another JDV object in the same or different duality views.

Described later herein are techniques for identifying the JDV objects to apply notification and validation directives when changed in these different ways and techniques to materialize versions of the JDV objects that are needed to carry out the notification and validation directives. Further, these techniques produce results that are consistent with the transactional semantics of a DBMS. Explaining these techniques is facilitated by an explanation of the following underlying principles.

### CASCADING MODIFICATIONS

As mentioned before, a JDV object is stored in normalized form across a set of base rows. The set of base rows is referred to herein as being contained by the JDV object. For example, a base row for JDV object 301 is the row in CUSTOMERS that includes the value 47 in column customer_id. For the array field OrderItem in JDV object 301, the base rows are the rows in table ORDER_ITEMS having the base column order_id=‘10089’.

Respective sets of base rows contained by JDV objects may overlap. Another JDV object belonging to JSON duality view ORDERS_OV may be for an order to the same customer and hence share the same base row in CUSTOMERS.

A change to a JDV object may change a base row that is also a base row in other JDV objects belonging to the same JSON duality view and/or to different JSON duality views, thereby cascading changes to other JSON duality view objects belonging to the same or different JSON duality view. Such a cascading modification is illustrated by the following update database statement JQB, which updates JDV object 301 in ORDERS_OV, which, in turn, changes a JDV object in a CUST_OV. The JQB and the definition of CUST_OV follow:
CREATE JSON RELATIONAL DUALITY VIEW CUST_OV AS
SELECT JSON {‘CustId”: customer_id
   ‘CustName’: full_name
   ‘CustEmail’: email_address
   }
FROM CUSTOMERS
JQB=UPDATE ORDERS_OV SET DATA—JSON_TRANSFORM(DATA, SET ‘$.CustInfo.CustName’=“A1 Cleaners”) WHERE ORDERS_OV.OrderID=‘10089’

Database statement JQB updates the CustName field in the CustInfo object field in JDV Object 301 using the JSON_TRANSFORM function. The OrderID value of JDV Object 301 is 10089. When a DBMS receives an update database statement that modifies a JDV object, the DBMS determines the one or more base rows that need to be updated to effect the update to the JDV object. In the case of JQB, the base row to change is the row in CUSTOMERS having the base column customer_id equal to 47. In addition, other JDV objects in ORDERS_OV may be for the same customer and, therefore, contain the same base row in CUSTOMERS. These JDV objects are also changed by JQB, albeit indirectly.

There is a JDV object in CUST_OV for the same customer. The JDV object contains the same base row in CUSTOMERS, and is therefore also changed by the update database statement JQB.

The base row in CUSTOMERS may also be updated by a DBMS that executes an update database statement that modifies the same JDV object in CUST_OV. The following database update command JQC specifies a change to the JDV object in CUST_OV, thereby changing the same base row in CUSTOMERS.
JQC=UPDATE CUST_OV SET DATA=JSON_TRANSFORM(DATA, SET ‘.CustName’=“A1 Cleaners”) WHERE CUST_OV.CustID=‘47’

In addition, the JDV objects in ORDER_OV representing ORDERS for the same customer are changed. These JDV objects contain the same base row in CUSTOMERS.

Finally, a database update statement directed to the underlying base table and base row rather than to a JDV object may change JDV objects in one or more JSON duality views. Database statement JQD below is an example.
JQD=UPDATE CUSTOMERS SET full_name=‘A1 Cleaners” WHERE customer_ID=‘47’
JQD changes the row in CUSTOMERS that includes the value ‘47’ in customer_ID. As explained above, the row is a base row of JDV objects in CUST_OV and ORDERS_OV.

Modifications to base rows and tables made by a DBMS in response to database statements directed to the base tables, such as JQD, rather than to a JDV object, are referred to herein as table-directed modifications. With respect to a modification made to a base row by a DBMS in response to a database statement that specifies a change to a JDV object in a JSON duality view (e.g., JQB and JQC), the modification is referred to as being directed to the JDV object and/or as being a view-directed modification or change that is directed to the JSON duality view.

A change or modification made to a JDV object by a DBMS in response to a modification or change directed to the JDV object is referred to as a direct change. A change to a JDV object caused by a table-directed modification or object-directed modification issued against another JDV object is referred to herein as an indirect change or modification.

### SCOPE

Notification or validation directives may be associated with a scope. The scope of a notification or verification directive of a duality view dictates whether indirectly changed JDV objects in the JDV object are journaled or validated according to the directive. For example, the scope of a notification directive defined for journaling changes to JDV objects in CUST_OV may specify not only to journal direct changes to JDV objects but also to journal indirect changes to JDV objects in CUST_OV.

According to an embodiment, there may be three scopes for a notification or validation directive. After describing each type of scope, examples are provided.

ALL scope—The directive of a JSON duality view is applied to any JSON object indirectly changed by a table-directed change or object-directed change to another JDV object in the same JSON duality view or another JSON duality view.

VIEW scope-The directive of a JSON duality view is applied to any indirectly or directly changed JSON object belonging to the duality view, where the object-directed change is directed to the JSON duality view. The directive is not applied to any JDV object simply because the JSON object is indirectly changed by table-directed modification or by a view-directed modification directed to another JSON duality view.

OBJECT scope-The directive of a JSON duality view is only applied to a JDV object that is directly changed. This scope is the default scope. Also, regardless of the scope of the directive of the JSON duality view, the directive is applied to the JDV object in the view that is directly changed.

### EXAMPLES OF APPLYING SCOPE

For purposes of illustration, a notification directive specifies to journal JDV objects in a JSON duality view ORDERS_OV. The scope of the directive is ALL. JQC is executed by a DBMS, which directly changes a JDV object for a customer object belonging to CUST_OV and indirectly changes JDV object 301 and other order JDV objects belonging to ORDERS_OV. Because the scope is ALL for the directive, JDV object 301 and the other indirectly changed JDV objects belonging to ORDERS_OV are journaled.

The JQD is also executed by the DBMS, making a table-directed change to the base row in CUSTOMERS that indirectly changes JDV object 301. Because the scope is ALL for the directive, JDV object 301 and the other JDV objects for the customer are journaled.

If, in the example, the scope for the directive on ORDERS_OV is VIEW, then the indirect changes caused by JQC and JQD to the JDV object 301 and the other JDV objects belonging to ORDERS_OV would not cause these JDV objects to be journaled.JQC specifies a change directed to CUST_OV but not to ORDERS_OV.JQD is table-directed and is obviously not directed to any JSON duality view.

However, JQB is directed to ORDERS_OV and indirectly changes other JDV objects in ORDERS_OV for the customer. Because the scope is VIEW, other JDV objects for the customer in ORDERS_OV are journaled.

In general, a change is view-directed when made for a DML statement having a duality view as the database object argument to an UPDATE clause or INSERT INTO clause. For example, in clause UPDATE CUST_OV in JQC, duality view CUST_OV is the database object argument. A change is table-directed when made for a DML statement having a database table as the database object argument to an UPDATE clause or INSERT INTO clause. For example, in the clause UPDATE CUST_OV in JQD, table CUSTOMERS is the database object argument.

When the scope of a directive requires applying the directive for a DML statement, the directive is referred to as being in scope. For example, if a notification directive for ORDERS_OV has a scope of view, the directive is in-scope for DML statement JQC, which is directed to ORDERS_OV.

### IDENTIFYING INDIRECTLY CHANGED JDV OBJECTS BASED ON DKS AND FKS

As demonstrated above, validation and notification directives of a duality view may not only be applied to directly changed JDV objects belonging to the duality view but may also be applied to indirectly changed JDV objects belonging to the duality view or belonging to other duality views. Applying these directives to indirectly change JDV objects requires a means for identifying the indirectly changed JDV object.

Described herein are procedures for identifying indirectly changed JDV objects, which are based on the following principles for how changes to base rows change JDV objects. An object-directed change or table-directed change to a JDV object changes one or more base rows of the JDV object. Any of these one or more base rows may be base rows of other JDV objects. The one or more base rows include determinant or foreign keys for DK and FK relationships, which are mapped to JSON fields (“key JSON fields”) within the JDV objects.

A key JSON field may be used in a query that includes a path-based predicate based on the key JSON field. The path-based predicate includes a predicate condition that requires that the key JSON field equal a respective primary or foreign key value. The query returns object IDs of JDV objects from duality views that satisfy the path-based predicate.

The following query statement, JAO1, is an example of a query that uses such a path-based predicate. JAO1 is used to determine the objects indirectly changed by database JQB, JQC, and JQD, which change the particular base row in CUSTOMER having customer_id equal to ‘47’.
JAO1=SELECT DATA.JVOID FROM ORDERS_OV
   WHERE JSON_EXIST(DATA, ‘$.CustInfo?(@.CustID==47)’

JAO1 returns any JDV object containing the changed base row in CUSTOMERS. The expression $.CustInfo?(@.CustID==47′)is a JSON path expression that includes a predicate on the key JSON field CustID, the predicate requiring that CustID be equal to 47. When compiling JAO1, a DBMS rewrites the query into a query that references and joins the underlying base tables ORDERS and CUSTOMERS using the primary key customer_id. The rewrite is based on the definition of the ORDERS_OV. The rewritten query may be further compiled into an execution plan that uses an index on the primary key customer_id of CUSTOMERS. The rewritten form is referred to as a normalized query form of the path-based query because the query accesses the underlying base tables of the respective duality view based on the joins defined for the base tables by the duality view.

Since the query is used to determine indirectly changed JDV objects that contain a changed base row, the query is referred to as an affected-object query. As another example of an affected-object query, the following affected-object query JAO2 may be used to identify the JDV objects indirectly changed by modifying the base row in PRODUCTS having the primary key product_id equal to 594.
JAO2=SELECT DATA.JVOID FROM ORDERS_OV
   WHERE JSON_EXIST(DATA,
      ‘$.OrderItems.[*].ProdInfo?(@.ProdID
      ==594)’

As mentioned before, an affected-object query that is path-based may be submitted to a DBMS, which rewrites the affected-object query into normalized form. In an embodiment, an affected-object query is initially formed in normalized form and then submitted for execution.

### AFFECTED OBJECT FRAMEWORK AND AFFECTED OBJECTS AND VIEWS

Affected object determination refers to operations that are performed to determine the set of indirectly modified JDV objects to which to apply validation or notification directives during the execution of a database statement and/or database transaction. According to an embodiment, affected object determination relies significantly on executing affected-object queries.

Affected object determination requires that certain operations be performed at different points during the execution of a database transaction before executing affected-object queries. Such certain operations include tracking information needed for forming the affected-object queries. These certain operations, along with those of affected object determination, are referred to herein together as the affected-object framework (AOF).

A JDV object that is indirectly changed by the execution of a DML statement is not necessarily an affected JDV object. For example, a DML statement may indirectly change a JDV object that belongs to a duality view for which no notification or validation directive is defined, and therefore, there is no notification or validation directive that needs to be applied to the indirectly changed JDV object in response to execution the DML statement.

As another example, execution of a DML statement that is directed to a first duality view indirectly changes a JDV object in a second duality view. The second duality view has notification and validation directives defined with scope VIEW. These directives of the second duality view are only applied to any indirectly changed JDV object changed by a DML statement directed to the second duality view, but not to a DML statement directed to another duality view, such as the first duality view. Because the indirectly changed JDV object is changed by execution of a DML statement directed to a JSON duality view different than the second JSON duality view, the directives of the second JSON duality view are not applied. The indirectly changed JDV object is not an affected JDV object with respect to the DML statement or the database transaction if that is the DML statement performed by the database transaction.

When and whether a directive of a JSON duality view should be applied during a database transaction to a JDV object depends on various attributes defined for the directive. As illustrated above, one such attribute is scope. If, in the previous example, the scope of a directive for the second JSON duality view was ALL, then the second JSON duality view would be an affected JSON duality view, and the indirectly changed JSON duality view would be an affected duality view.

Other directive attributes that determine when and/or whether to apply a directive to a modified JDV object include “directive application time” and “On-DML type”. Directive application time is a point or stage of executing a database transaction, which includes, inter alia, at the end of executing a database statement (AFTER STATEMENT) or at commit time (AT COMMIT). On-DML type specifies a category of DML statement executed against a JDV object or table for which a directive is applied to a modified JDV object.

### VIEW DEPENDENCY TABLE

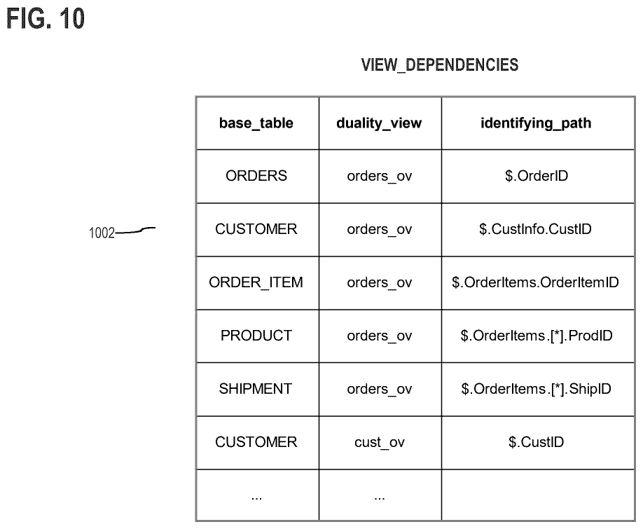

According to an embodiment, an affected-object query is formed using information stored in a “view dependency table”. FIG. 10 shows an illustrative view dependency table VIEW_DEPENDENCIES. VIEW_DEPENDENCIES includes columns base_table, duality_view, and identifying_path. For each row in VIEW_DEPENDENCIES, the combination of the values in these columns forms a dependency mapping that maps a particular table to a duality view and an identifying path. The duality view includes the particular table as a base table; the duality view is referred to herein as being dependent on the particular table. The identifying path is a path expression that identifies a key JSON field defined by the duality view that corresponds to the primary or foreign key of the base table. The identifying path is used as a path-based predicate in affected-object queries, as shall be explained later. The particular table, duality view, and identifying path are stored in columns base_table, duality_view, and identifying_path, respectively.

For example, dependency mapping 1002 maps duality view ORDERS_OV to base table CUSTOMER and identifying path $.CustInfo.CustID. This is the path of the key JSON field CustId of ORDERS_OV that holds the primary key value for table COSTUMERS. The identifying path is used to form a path-based predicate in an affected-object query.

One or more dependency mappings for a duality view are generated or added to a view dependency table when the duality view is defined.

### AFFECTED OBJECT FRAMEWORK

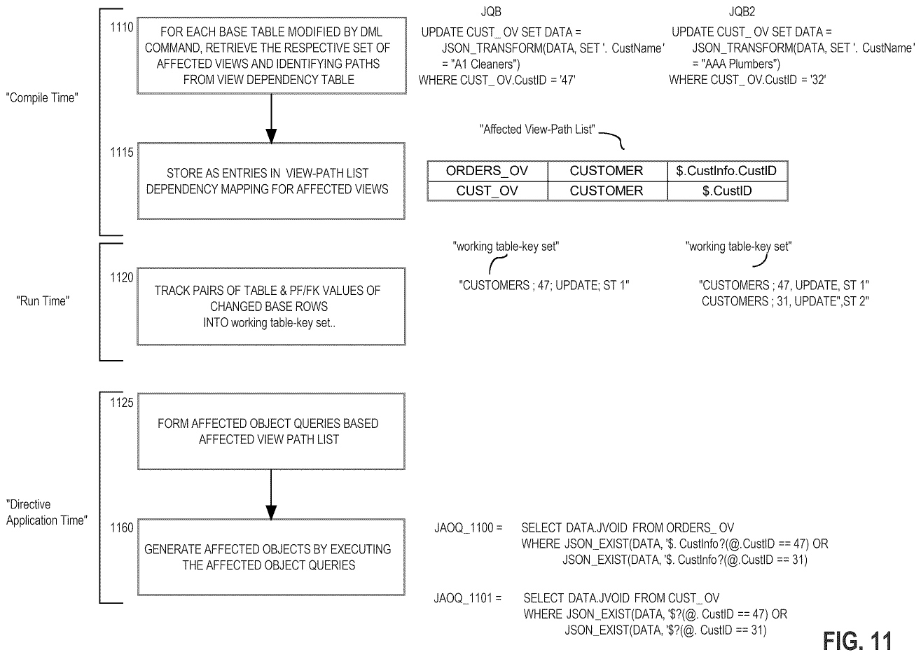

FIG. 11 depicts a flow of operations performed for AOF. The operations are performed at different phases within a database transaction that executes one or more DML statements. These phases include “compile time”, which occurs when compiling a DML statement, “run time”, which occurs when executing a compiled DML statement to make changes to a database object, and “directive application time”, e.g., AFTER STATEMENT and AT COMMIT.

A directive that should be applied to a JDV object at a directive application time of a database transaction, based on attributes defined for the directive and the associated duality view, is referred to as an affected directive with respect to the directive application time. A directive may be an affected directive at application directive time “AFTER STATEMENT” but not “AT COMMIT”. For purposes of exposition, AOF is initially described in the context of a notification directive that has an on-DML type covering all categories of DML operations (INSERT, UPDATE, and DELETE) and that has a directive application time of AT COMMIT. Thus, in the following description of AOF, affected directives are affected directives for AT COMMIT and for all on-DML types.

AOF, as depicted in FIG. 11, is illustrated using illustrative DML statements JQC and JQC2. JQC is shown in FIG. 11 and was previously described. JQC2, like JQC, specifies a view-directed modification that is directed to CUST_OV and changes a base row in CUSTOMER. JQC and JQZ change base rows where primary key customer_id equals 47 and 31, respectively. For purposes of exposition, a row may be referred to herein by its primary key value. Row 47 and row 31 in CUSTOMER refer to rows having customer_id equal to 47 and 31, respectively.

Referring to FIG. 11, the compile-time and run-time operations are performed on a per DML statement basis. JQC is first compiled. During the compilation, the DBMS determines the base tables that will be updated or otherwise modified and retrieves dependency mappings for those base tables from VIEW_DEPENDENCIES. (1110) For each dependency mapping mapped to one of the base tables, the definition of any directive defined by the respective duality view of dependency mapping is examined to determine whether the directive is an affected directive. If the directive is an affected directive, then the duality view is an affected duality view. The determination is made by determining whether a defined attribute of a directive means the directive is an affected directive. For example, the scope of a directive of a duality view may be ALL, making the directive an affected directive for any change to a base table of the duality view.

Each retrieved dependency mapping that maps a duality view that has been determined to be an affected duality view is added to an affected view-path list. (1115) FIG. 11 shows the affected view-path list created during the compilation of the JQC.

In an embodiment, once a cursor is compiled, it may be stored as a shared cursor in a shared cursor pool for subsequent reuse when a DBMS compiles a DML statement that may reuse the shared cursor. Reusing the shared cursor avoids much of the work of compiling a database statement.

A shared cursor stores information on an execution plan and other information useful in executing the execution plan. Among the information stored is the affected view-path list. Using a shared cursor thus avoids the need to access VIEW_DEPENDENCIES to retrieve dependency mappings. As an optimization, instead of querying the VIEW_DEPENDENCIES table over and over for every DML compilation, a flag/bit is examined in the database table's metadata in the database dictionary. The flag/bit is maintained to indicate whether a table is involved in a directive, thus saving compilation cost.

Once compiled, JQC is executed, updating base row 47 in CUSTOMERS. The combination of the table CUSTOMERS, foreign key value 47, the DML operation type that changed base row 47, which is UPDATE, and a database statement ID ‘ST 1’, are stored as an entry in a “working table-key set”. (1120) An entry in a working table-key set is referred to herein as a table-key entry. As DML statements are executed within a database transaction, table-key entries are accumulated. A database statement ID identifies the database statement within a database transaction whose execution changed the respective base row. The database transaction ID may be used during validation with the directive application time of AFTER STATEMENT, as explained later.

Next, within the database transaction, JQC2 is compiled using the shared cursor stored for JQC, which minimizes computation needed for compiling JQC2. The affected view-path list stored for the shared cursor is retrieved. However, no new entries are added to the current affected view path list because the list contains no dependency mappings that are not already in the current affected view path list.

Once compiled using the shared cursor, JQC2 is executed, changing the base row 31 in CUSTOMERS. The combination of the table CUSTOMERS, foreign key value 31 in customer_id, DML operation type UPDATE, and database statement ID ‘ST 2” are stored in a table-key entry in the working table-key set. (1120)

Next, during directive application time (AT COMMIT in the current example) of the database transaction, the affected-object queries are formed to retrieve affected duality views changed by the database transaction. (1125) The affected object queries formed for the database transaction are JAQQ_1100 and JAQQ_1101. The affected object queries are formed based on the working table-key set and the affected view-path list.

In general, an affected object query is generated for each dependency mapping in the affected-view path list. An affected object query generated includes a path-based predicate based on the duality view and identifying the path in the dependency mapping. If there are multiple table-key entries in the working table-key set that are applicable to a dependency mapping, a path-based predicate may be a conjunctive predicate based on the identifying path and the different key values in the entries, as shown in the case of JAOQ_1100 and 1101.

Finally, affected object determination is performed by executing the formed affected-object queries, which return the object IDs of affected objects. (1130)

### POPULATING THE WORKING TABLE-KEY SET OF OBJECT-DIRECTED COMMANDS

In the previous description of the working table-key set, entries are added to the working table-key as individual base rows are updated in response to a table-directed DML statement that identifies the base rows (e.g., by a predicate explicitly referring to a column of the respective table). In the case of execution of a DML statement that is object-directed to a JDV object that contains multiple base rows, the base rows to update, insert, or delete are not identified by the DML statement. However, to effect object-directed DML statements, the DBMS determines and generates the DML statements needed to modify the underlying base rows of the JDV object. As these DML statements are executed, the working table key set is populated accordingly.

For example, to process an object-directed statement that inserts a JDV object, the DBMS generates an insert DML statement for the root row and adds a working table-key set entry for the root table of the root row, having the primary key of the root row and a DML operation of INSERT. To process an object-directed command that deletes a JDV object, the DBMS generates a delete DML statement for the root row and adds a working table-key set entry for the root table of the root row, having the primary key of the root row and a DML operation of DELETE. To process an object-directed command that modifies an object field of a JDV object, the DBMS generates an update DML statement for a base row for the child base table corresponding to the object field and adds a working table-key set entry for the child base table, having the primary key of the base row, and a DML operation of UPDATE.

### TRANSACTIONAL PROCESSING CONSISTENCY

As shall be explained, validation and notification directives are applied in a manner that is transactionally consistent. Therefore, an explanation of transaction processing and transactional consistency is useful.

Rows in a database, including base rows of a JDV object, are changed by database transactions. A database transaction makes the changes permanent by committing the changes. The changes committed by a database transaction are also assigned to a unique transaction commit SCN (system change number) that is not associated with other changes committed by other database transactions. A database transaction is assigned a transaction commit SCN that is greater than any previously assigned SCN. The order of the transaction commit SCNs of database transactions reflects the respective order of the changes committed by the database transactions.

As database transactions commit changes to a database, the database changes from one committed state to another, each committed state being associated with a distinct transaction commit SCN. The committed state of a database as of a given transaction commit SCN reflects the changes committed at or before the transaction commit SCN.

A row may be changed by multiple database transactions. Each change committed by a database transaction to the row is associated with a row commit SCN, which is the transaction commit SCN of the database transaction that made the change. The state of the row that reflects the change is referred to as the state or committed state of or associated with the row commit SCN. The state or committed state of a row that is consistent with an SCN is the committed state of a row at the row commit SCN that is closest or equal to the SCN.

A row may be associated with multiple row commit SCNs. Versions of the row are associated with the multiple row commit SCNs, respectively, or, in other words, each row commit SCN of a row is associated with a committed state of the row. The latest row commit SCN of a row is referred to as the row's current row commit SCN.

Not every SCN generated by a DBMS for a database is a transaction commit SCN. SCNs are generated for a variety of purposes and events. A current SCN is maintained by a DBMS for a database. To generate an SCN to assign to an event, such as generating a transaction commit SCN to assign to the commit of a database transaction, the current SCN is incremented and then assigned, or assigned and then incremented. The current SCN is monotonic.

When a database transaction is initiated, the database transaction is assigned a transaction start SCN. When a database transaction commits, a transaction commit SCN is assigned to a committed database transaction, and the assigned transaction commit SCN is greater than or later than the transaction start SCN of the database transaction.

As a database transaction executes and changes database data, the database transaction may execute database read operations (e.g., for query statements or DML statements) to read database data from the database. The read operations are performed according to a protocol referred to herein as a consistent read. In a consistent read, there are two types of “in-flight changes”. In-flight changes are changes made by in-flight database transactions, which are database transactions that have not been committed or otherwise terminated. With respect to a given in-flight database transaction, in-flight changes being made by another uncommitted database transaction are referred to herein as external in-flight changes. In-flight changes being made by the given database transaction may be referred to herein as local in-flight changes with respect to the given database transaction. For purposes of exposition, with respect to a database transaction, external in-flight changes may be referred to as external dirty changes; the data or rows being changed by external changes are referred to herein as externally dirty data or rows. The local in-flight changes of the database transaction may be referred to as the local dirty changes with respect to the database transaction; the data or rows changed by the local changes are referred to as locally dirty.

In a DBMS, when a database transaction changes a row, it first obtains an exclusive lock on the row. The lock is released when the database transaction is committed. Locking rows in this way means that with respect to a row in a database, only one in-flight database transaction is changing the row. Once an in-flight database transaction obtains an exclusive lock, no other in-flight database transaction may change the row until the database transaction commits or otherwise terminates.

### CONSISTENT READ

When executing a database statement in consistent read mode, rows are read, processed and/or returned in a way that reflects local dirty changes. For rows not changed by the database transaction, the rows are processed and returned in a way that is consistent with their committed state as of a “snapshot time” assigned to the execution of the database statement. A snapshot time is an SCN. Some of the rows not changed by the database transaction may be externally dirty. A consistent read mechanism adjusts the state of these rows for the database transaction so that the state is consistent with the snapshot time.

When a state of a row read or otherwise processed by a database transaction reflects changes made to the row, the changes are referred to herein as being visible or seen by the database transaction. When a state of a row that is read or otherwise processed by a database transaction does not reflect the changes made to the row, the changes are referred to herein as being not visible or not seen by the database transaction. In consistent read mode, local dirty changes of a database transaction are visible to the database transaction, while externally dirty changes are not visible. The local dirty changes of the database transaction are not visible to other database transactions under consistent read.

A snapshot time is assigned to the execution of a database statement when the execution of a database statement is requested by the database transaction or otherwise commenced by the database transaction. If a database transaction executes different database statements at different times, the executions are assigned different snapshot times, with the later execution of a database statement being assigned a later snapshot time.

For example, a first database transaction begins and executes a DML statement that makes first changes to a first set of rows in an employee table. Later, a second database transaction begins execution and makes second changes to a second set of rows in the employee table.

After the second changes are made by the second database transaction and before either database transaction commits, the first database transaction executes a first database statement that reads rows from the employee table. The first query is assigned a snapshot SCN of 15. Execution of the query returns the first set of rows changed by the first database transaction and the second set of rows changed by the second database transaction. The first set of rows that are read reflects local dirty changes made by the first database transaction, and the second set of rows that are read does not reflect the external dirty changes made by the second database transaction.

After execution of the first query, the second database transaction commits and is assigned a transaction commit SCN of 25. Next, the first database transaction executes a second query with a snapshot time of 30. The execution of the second query reads rows from the employee table that include the second set of rows. The second set of rows now reflects the changes made by the second database transaction.

### TRANSACTIONAL CONSISTENCY WHEN APPLYING NOTIFICATION DIRECTIVE

For a given database transaction, a change to a single base row in a table may indirectly change multiple JDV objects. These affected JDV objects have other base rows other than the changed base row. A set of the other base rows may be subject to external in-flight changes made by other concurrent in-flight database transactions.

A notification directive may require logging all new versions of the affected JDV objects for the given database transaction to a history table. When committed, the given database transaction will be assigned a transaction commit SCN. A goal of logging the new versions is that the new versions reflect base rows that have a respective committed state that is transactionally consistent with the transaction commit SCN of a given database transaction. That is, the state of the base row version used to generate a new version of the JDV object is consistent with the transaction commit SCN of the given database transaction.

In general, new materialized versions are stored in memory and later inserted into the history table. Generating a new version of changed JDV objects to store in materialized form for a database transaction in the history table may require significant preprocessing that includes the execution of multiple database statements that each return new versions of affected objects. When the insert into the history table of the new version of an affected object is committed within a particular database transaction, a base row from which a new version of the object to store may have been changed (without preventive measures discussed later) by another in-flight database transaction that committed before the particular database transaction. When the materialized new version of the affected object was generated, the base row had a current row commit SCN that is no longer current when the particular database transaction commits because another database transaction superseded the current row commit SCN of the base row. Hence, the base row and the new JDV object version from which the base row was generated do not reflect the committed stated of the base row that is consistent with transaction commit SCN of the particular database transaction; the JDV object was generated from a committed state of the base row that has row commit SCN that is not the latest for the base row with respect to the transaction commit SCN of the particular database transaction.

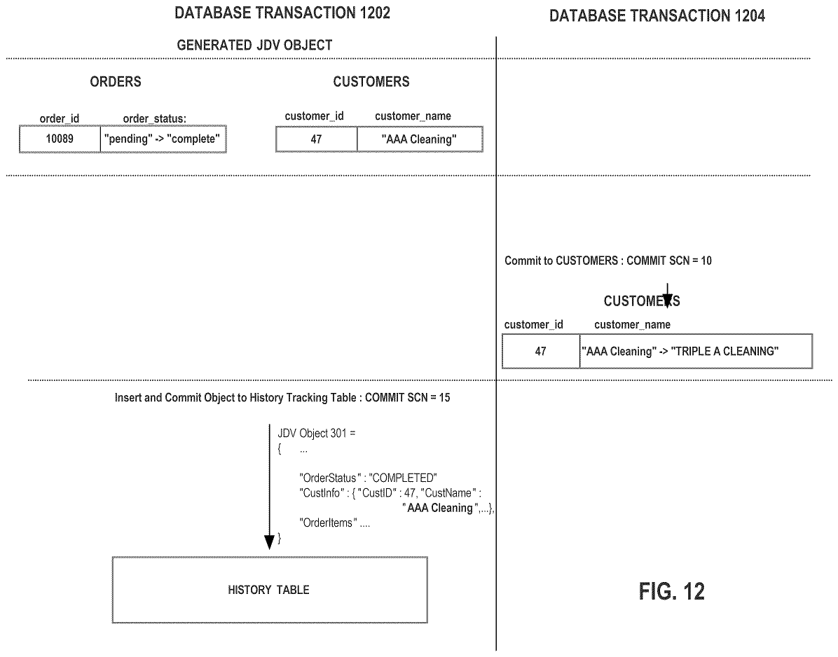

FIG. 12 illustrates such a transactional inconsistency. FIG. 12 illustrates changes being made by in-flight database transactions 1202 and 1204. Database transaction 1202 changes row 10089 in ORDERS, the root row of JDV object 301. JDV object 301 is an affected object for database transaction 1202, and the new version of the JDV object is generated to be stored in a history table. Generating the new version entails executing a JDV construction query, which retrieves the base rows to generate the new version of JDV object 301 for insert into the history table. Among these base rows is base row 10089 from ORDERS and base row 47 from CUSTOMERS. Other base rows of JDV object 301 are not shown. Database transaction 1202 has a lock on base row 10089 in ORDERS but not on base row 47 in CUSTOMERS because the database transaction is only changing row 10089 in ORDERS.

Meanwhile, database transaction 1204 updates row 47 in CUSTOMERS, changing customer_name from “AAA Cleaning” to “TRIPLE A Cleaning”. Updating row 47 in CUSTOMERS required locking the row.

Database transaction 1204 then commits and is assigned transaction commit SCN=10. The latest row commit SCN of base row 47 is 10. The commit occurs after database transaction 1202 executes the JDV construction query to generate the new version of JDV object 301. Note that the new version generated includes the old value of customer_name “AAA Cleaning” as field value for CustName because database transaction 1204 had not been committed when the JDV construction query to generate the new version of JDV object 301 was executed. The snapshot time of the query was less than the transaction commit SCN of database transaction 1204.

Finally, database transaction 1202 inserts the previously generated new version of JDV object 301 into the history table. However, the CustName field of the previously generated new version is set to the previous value of customer_name, which is “AAA cleaning”. Database transaction 1202 has a transaction commit SCN of 15. The closest row commit SCN of base row 47 is 10. The committed state of base row 47, consistent with transaction commit SCN 15, should include the new value “TRIPLE A CLEANING” for customer_name to be transactionally consistent with transaction commit SCN 15; the new version of the JDV object 301 should also include the new value “TRIPLE A CLEANING” in CustName. Therefore, the new version of JDV object 301 stored in the history table is transactionally inconsistent with the transaction commit SCN 15 of the database transaction that inserted the new version.

A reason for the transactional inconsistency is that the base row of JDC object 301 was not being changed by the database transaction and was, therefore, unlocked. One way to avoid this transaction inconsistency when applying directives is to “lock down the base rows” of the affected objects of a database transaction. Locking down the base rows of affected objects of a database transaction means that other in-flight database transactions are prevented from committing changes to those base rows. The latest row commit SCNs of the base rows cannot be increased and will, therefore, be the row commit SCNs of the base rows closest to the transaction commit SCN when assigned. Having all the base rows of affected objects of a database transaction locked down is referred to herein as base row lockdown.

Base row lockdown may be achieved by lock synchronization at the base row level by obtaining locks on all the base rows of the affected objects. Lock synchronization refers to a given executing entity (e.g., processes, threads, database transactions) among multiple concurrently executing entities obtaining a set of exclusive locks before performing a set of operations, where the set of exclusive locks includes at least one exclusive lock that must be obtained by any of the other concurrently executing entities before any of them perform an operation that could interfere with proper execution of the set of operations being executed by the given entity. Concurrently executing entities obtaining a lock or set of locks for purposes of lock synchronization are said to synchronize on the lock or the set of locks. With respect to the respective operations for which the executing entities are synchronizing locks, each entity may be referred to as synchronizing its respective operations.

A set of lockable objects (e.g., rows) that an executing entity locks for the purpose of lock synchronization is referred to herein as a synchronization set. A synchronization set on which exclusive locks must be obtained on each member of the set by an executing entity that effects (1) preventing other concurrently executing entities from interfering with the proper execution of a set of operations and (2) preventing the executing entity from interfering with proper execution of other concurrently executing entities a respective set of operations, is referred to herein as a complete or as a complete synchronization set. A synchronization set that cannot fulfill this purpose is referred to herein as incomplete.

In the above example, the executing entities are database transactions 1202 and 1204. A synchronization set that is complete for base row lockdown for (1) database transaction 1202 includes each base row of JDV object 301, including base row 47 of CUSTOMERS, and for (2) database transaction 1204, includes base row 47. Database transactions 1202 and 1204 can synchronize on a lock of base row 47. For example, database transaction 1202 obtains a lock on base row 47 (as well as other base rows) before applying the notification directive to generate new versions of affected objects, inserting them into the history table, and then committing and releasing the lock. The synchronization set of database transaction 1204 includes base row 47, which database transaction 1204 locks before changing row 47 and committing. After committing, database transaction 1204 releases the lock of row 47. If database transaction 1202 first obtained the exclusive lock on row 47, database transaction 1204 would be blocked from obtaining the lock on row 47 and therefore blocked from committing the update to row 47 before database transaction 1202 committed, and blocked from causing the transactional consistency to the application of the notification directive being applied by database transaction 1202.

While synchronization at the row level could prevent such transaction inconsistency, obtaining the locks at the row level requires substantial processing by a DBMS, which includes substantial overhead in the form of a system-wide lock contention system. According to an embodiment, a complete synchronization set is comprised of entities at a higher level of granularity than a row, i.e., the object level and transaction level. Lock synchronization at these levels requires much less locking and processing and avoids the overhead of locking contention that would occur at the row level. Locking synchronization at the object level and transaction level provides base row lockdown for affected objects of a database transaction. If concurrently in-flight database transactions are changing any base row of the same affected objects, the first of these database transactions to obtain locks on the affected objects may perform operations for notification directives without changes to these base rows being committed by any of the other concurrently in-flight database transactions.

The following is an example of lock synchronization at the object level, where the synchronization set includes affected objects. Database transaction 1202 determines that JDV object 301 is an affected object, obtains a lock on JDV object 301, and then generates the new version of JDV object 301. Meanwhile, database transaction 1204 updates row 47 in CUSTOMERS, determines that JDV object 301 is an affected object, and in response, attempts to obtain a lock on the JDV object 301. However, database transaction 1204 is blocked from obtaining the lock on JDV object 301 because database transaction 1204 has the lock.

Database transaction 1202 commits the insert into the history table with transaction commit SCN=10, with CustName=“AAA Cleaning”, which is transactionally consistent with the database transaction's transaction commit SCN=10. The update to customer_name being made by database transaction 1204 cannot be committed until later with a higher transaction commit SCN.

Next, database transaction 1202 releases the lock, allowing database transaction 1204 to obtain a lock on the JDV object and commit the update to row 47 in CUSTOMERS.

To provide transactionally consistency for the application of notification directives, an object serialization algorithm is provided. The object serialization algorithm uses a synchronization set that includes affected objects returned by affected-object queries.

### LATENT OBJECT INSERTS

As indicated above, a key operation in the object serialization algorithm is to identify affected objects needed for a synchronization set. The identification may be carried out by running affected object queries in consistent read mode to return a set of affected JDV objects and then locking the affected JDV objects. However, the set of JDV objects returned in this way is not, by themselves, a complete synchronization set under certain scenarios.

One such scenario is the latent object insert scenario. A latent object insert involves concurrently executing in-flight database transactions, where one of the database transactions (inserting database transaction) is inserting a JDV object. An inserted JDV object includes as base rows a newly inserted root row but may include existing base rows in a descendant table, where the base row existed before the inserting database transaction began executing. Importantly, another currently in-flight database transaction may be updating the existing base row because the base row is not locked by the inserting database transaction.

To form a synchronization set, the other database transaction runs affected-object queries in consistent read mode before the inserting database transaction commits the insert of the JDV object. Consequently, the JDV object being inserted is not seen by the other database transaction, that is, not returned as an affected object by any affected object query executed by the other database transaction. A complete synchronization set for either database transaction should include the JDV object being inserted to lock down all the base rows of the JDV object. However, since the other database transaction cannot see the JDV object being inserted, the synchronization set of the other database transaction omits the JDV object and does not synchronize on a lock of the JDV object. As a result, a transaction inconsistency can occur when either database transaction applies a notification directive.

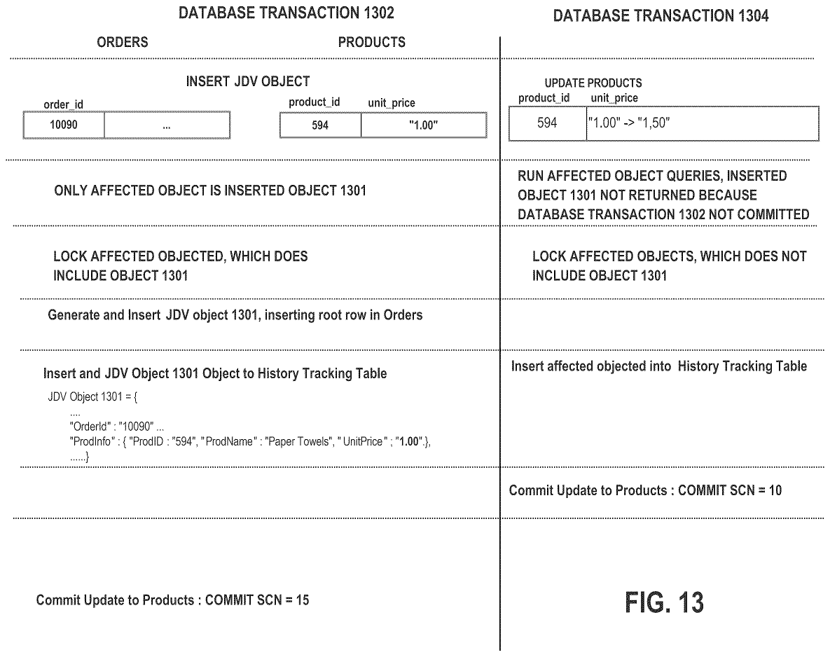

FIG. 13 illustrates a transactional consistency that can occur when latent inserts are not considered. Referring to FIG. 13, database transaction 1302 and database transaction 1304 are concurrent in-flight database transactions. Database transaction 1302 is inserting a JDV object 1301 into ORDERS_OV, which entails inserting a root row into ORDERS and new base rows in ORDERS_ITEMS; each of the base rows has an FK:DK relationship with table PRODUCTS. Base rows of JDV object 1301 include rows in PRODUCTS that pre-exist database transaction 1302. FIG. 13 shows root row 10090 in ORDERS and base row 594 in PRODUCTS having product_id=594.

Database transaction 1304 is updating the unit_price of the base row 594. The unit price is being updated from 1.00 to 1.50. Under the consistent read mode, the updated price of 1.50 is not visible to database transaction 1302.

ORDERS_OV has a notification directive having scope ALL. This scope requires journaling new versions of JDV objects in ORDERS_OV to the history table for any changes to a base row of the JDV objects.

To apply the notification directive for ORDERS_OV, database transaction 1304 identifies the affected objects to lock by running affected object queries. Under consistent read mode, JDV object 1301 is not visible to database transaction 1304; more specifically, root row 10090 of the JDV object 1301 is not visible to database transaction 1304 because database transaction 1302 has not been committed. Therefore, the affected object queries executed by database transaction 1304 do not return JDV object 1301 as an affected object. As a result, only database transaction 1302 locks JDO 1301, and the database transactions are not synchronizing on a lock on JDV object 1301.

In the current scenario, after database transaction 1302 locks JDV object 1301, it generates JDV object 1301 to store in the history table and proceeds to insert JDV object 1301 into the history table. The UnitPrice field value is 1.00 and not 1.50 as being updated by database transaction 1304, which is updating column unit_price to 1.50 in row 594. Before database transaction 1302 commits, database transaction 1304 commits the update to row 594. The transaction commit SCN of the commit is 10.

Next, database transaction 1302 commits with a transaction commit SCN of 15. The UnitPrice of 1.00 is transactionally inconsistent with the most recently committed unit_price of 1.50 in base row 594.

If database transaction 1302 had been committed after database transaction 1304, a transaction inconsistency would nevertheless have also resulted. Database transaction 1304 would not have included JDV object 1301 in the history table even though the insert of JDV object 1301 had been committed previously.

Another form of a latent insert is a “logical insert” into a duality view caused by updating a column of a filter predicate defined by a duality view. For example, a duality view ORDERS_ACME is similar to ORDERS_OV, except that ORDERS_ACME includes a filter predicate that filters on customer_id =“11”, the customer ID for ACME. Specifically, ORDERS_ACME includes instead of the clause “FROM ORDERS ord”, the clause “FROM ORDERS ord WHERE customer_id=“11”. Updating a customer_id to 11 in a root row in ORDERS effectively inserts the JDV object into ORDER_ACME.

A column of a filter predicate defined by a duality view that, when updated, may cause such logical inserts is referred to herein as a view filtering column. Updating a view filtering column may also cause logical deletes.

A DML delete command that deletes a JDV object can also lead to transactional inconsistency. For example, a given database transaction may delete a JDV object, which involves deleting the root row for the JDV object. When the affected object queries are run in consistent read mode, the deleted JDV object is not returned. However, it should be locked to provide sufficient base row lockdown. For example, another currently in-flight database transaction may have identified the JDV object as an affected JDV object to be journaled in the history table before the given database transaction commits, but does not commit an insert of the JDV object into the history table until after the given database transaction commits. To be transactionally consistent, the JDV object should not be inserted into the history table.

### SPECIAL CAPABILITIES FOR OBJECT SERIALIZATION ALGORITHM

Various capabilities are important to the object serialization algorithm. These are (1) flashback read mode, (2) current read mode, (3) transaction locking, and (4) enqueue locking.

Flashback read mode is a mode of executing a database statement by a database transaction that is similar to consistent read mode, except locally dirty changes are not visible to the database transaction while executing the database statement. This mode makes, inter alia, a JDV object deleted by the database transaction visible to the database transaction when executing an affected-object query. Thus, if a database transaction deleted a JDV object, the JDV object would be returned and locked.

Current read mode is a mode of executing a database statement by a database transaction in which read operations reflect locally and externally dirty changes, i.e., uncommitted changes made by the database transaction and other database transactions are visible to the database transaction. As shall be explained in greater detail, the current read mode makes visible uncommitted database transactions that are changing a base row of a JDV object that is being inserted by an inserting database transaction. These transactions are locked to form a complete synchronization set.

In enqueue locking, exclusive locks are issued on “enqueue values”; each issued lock locking a particular enqueue value. Enqueue values used herein are object IDs and transaction IDs. To exclusively lock a JDV object within a DBMS, a database transaction locks the object ID of the JDV object. To exclusively lock a transaction, a database transaction locks the transaction ID of the transaction.

In an embodiment, database transactions take locks on a set of enqueue values by ordering the enqueue values and locking the enqueue values in that order. This measure ensures database transactions attempt locks in the same relative order, thereby avoiding deadlocks.

### OBJECT SERIALIZATION ALGORITHM

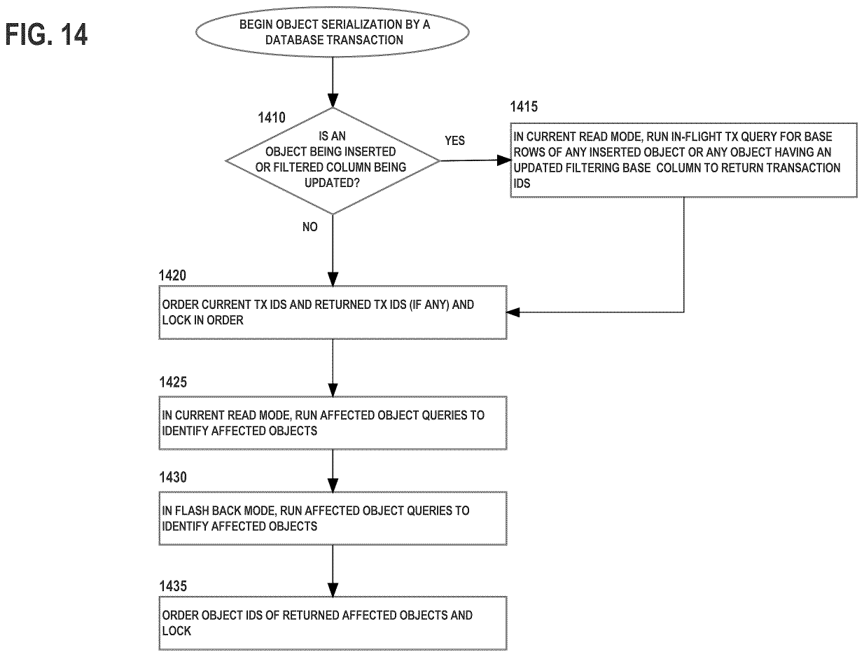

FIG. 14 illustrates an object serialization algorithm according to an embodiment. The algorithm is being executed by a “current” database transaction to achieve base row lockdown in order to apply notification directives at commit time. The current database transaction has executed one or more DML statements. In the following description, an object ID and transaction ID are locked using enqueue locking.

The algorithm involves running affected-object queries. The affected object queries are generated using the AOF described previously. As described, the AOF framework involves operations performed during compile time, such as generating an affected view-path list, tracking DK/FK values of changed base rows in the working table-key set during runtime, and operations performed at directive application time, which include forming the affected-object queries.

Referring to FIG. 14, the current database transaction determines whether the current database transaction is inserting a JDV object or updating a JDV object in a way that updates a view filtering column of the JDV object. (1410)

If the determination is YES, then in the current read mode, the current database transaction executes “in-flight transaction queries” on the base rows of any JDV object being inserted or having a view filtering column being updated. In-flight transaction queries include a pseudo-column that contains, for a returned row, a database transaction ID that currently has a row locked, if any(1415)

Next, the database transaction locks a set of database transaction IDs that include the database transaction's own ID and the database transaction IDs returned by execution of any in-flight transaction query, if any. (1420) To lock the set of database transaction IDs, the set is ordered by database transaction ID and locked in that order. A concurrently in-flight database transaction modifying any of these base rows would have taken a lock at operation 1420 on a database transaction ID returned by the in-flight transaction queries, causing the current database transaction and in-flight database transaction to synchronize on the database transaction ID. If the in-flight database transaction had obtained the lock first, the current database transaction is blocked from proceeding further until the lock is released by the in-flight database transaction.

Next, in the current read mode, affected object queries are executed to return the object IDs of affected objects. (1425) Object IDs of the uncommitted deletes of JDV objects are not returned by the affected-object queries run in this mode. To capture these deleted JDV objects, affected object queries are run in flashback read mode, which returns the object IDs for these uncommitted deletes. (1430)

The object IDs returned by the affected object queries run in current read mode and flashback read mode are ordered, and locks are taken on the object IDs in that order. (1435)

At this stage, base row lockdown has been achieved for the affected objects.

The object IDs returned by the current read mode execution of affected-object queries are referred to herein as the current read mode list. The object IDs returned by the flashback read mode execution of affected-object queries are referred to herein as the flashback read mode list.

### NOTIFICATION DIRECTIVES-REPLICATION LOG

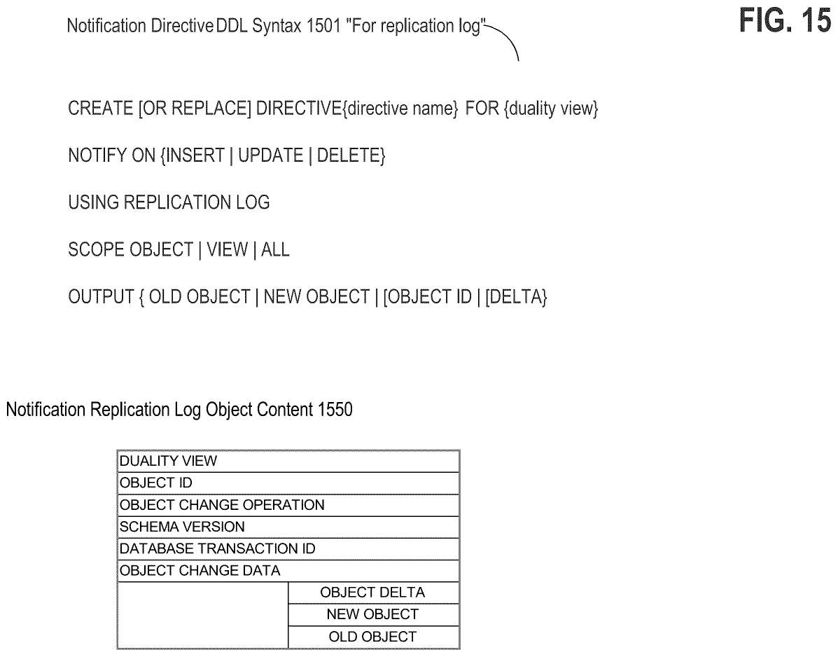

FIG. 15 depicts a DDL syntax for defining a notification directive. As mentioned, a notification directive dictates whether to journal new, modified, or deleted JDV objects of duality views to a replication log and/or a history table. The term journal is used herein to mean tracking and recording changes to data, such as to JDV objects, to a persistent journal log, such as the replication log and history table described herein. A replication log is configured and optimized for replicating the changes to JDV objects, while the history table is configured and optimized for querying changes that have been made to JDV objects. A journal may also be an event queue, such as Apache Kafka or Oracle's TxEventQ, or the infrastructure of another DMBS that accepts notifications and events about changes to JSON objects.

Referring to FIG. 15, the syntax provides for defining a notification directive for replication. A syntax for a notification directive for history tracking shall be later described. In DDL syntax 1501, the DIRECTIVE and FOR clauses take arguments for defining, respectively, the directive name and the duality view for which the directive is defined.

The NOTIFY ON clause specifies which on-DML types for which to a journal JDV objects. In an embodiment, INSERT and DELETE options are limited to DML operations that are object-directed. The SCOPE clause specifies the scope of the notification directive. The USING clause specifies to the journal to use JDV objects for replication, such as a replication log or event queue.

The OUTPUT clause specifies options for “journal object content” to record changes to a JDV object. The first option, NEW OBJECT, is to include a materialized new version of the changed JDV object. A second option, OLD OBJECT, is to include a materialized old and new version of the changed JDV object. A third option, DELTA, is to include a “JSON delta”, which describes only the changes in the JDV object. An example of a format that may be used for JSON delta is the JSON Merger Format, as defined in, for example, Internet Engineering Task Force 7396 (ISN 2070-1721). Both the first and second options include the duality view identifier of the changed JDV object. A finale option, OBJECT ID, is to only journal the object ID of the changed JDV object.

FIG. 15 also depicts notification replication log object content 1550, an embodiment of content stored for a JDV object that is journaled to the replication log (“journaled object”). Content 1250 includes fields:

DUALITY VIEW: identifies the JSON duality view to which the journaled object belongs.

OBJECT ID: object ID of journaled object.

OBJECT CHANGE OPERATION: the type of change operation for which a journaled object is journaled, which may be INSERT, UPDATE, or DELETE. The change operation is at the object level and not the base row level. For example, a change to a JDV object may be an insert of a new child base row to an existing JDV object whose content is already stored in committed base rows. The content of the JDV object was updated by the insertion of the child base row, but the JDV object itself was not inserted; the root row has already been committed. An insert or delete of a JDV object entails an insert or delete of the respective root row of the JDV object. An algorithm for determining the object change operation is described later.

SCHEMA VERSION: In a DBMS, database schemas evolve, going from one version to a subsequent version. In an embodiment, each version is tracked by the DBMS. Each database transaction committed is associated with a DBMS schema. SCHEMA VERSION identifies the version of the schema associated with the database transaction that journaled the JDV object.

DATABASE TRANSACTION ID: The Transaction ID of the database transaction that journaled the JDV object.

OBJECT CHANGE DATA: The content of the object change data is generated in response to the parameters that specify the journal object content in the DDL command that defines the notification directive. In an embodiment, the content of the object change data is defined by the OPTION clause. IF NEW OBJECT is specified as a parameter of the OPTION clause, then the object change data field contains the new version of the journaled object. OLD OBJECT can only be specified if NEW OBJECT is also specified, and if so, the previous version of the journaled object is included in the object change data. If DELTA is specified as a parameter, then a JSON delta is included in the object change data. If OBJECT ID is specified as a parameter, journal object content may not include an object change data field as the object ID is already stored in the journal object content.

In an embodiment, journal object content may also include information about the database session executing the database transaction that journaled the JDV object. Such information includes information about the current DBMS environment and session, including details about the user, name, and/or ID of the database or schema, and session parameters.

### OBJECT CHANGE OPERATION DETERMINATION

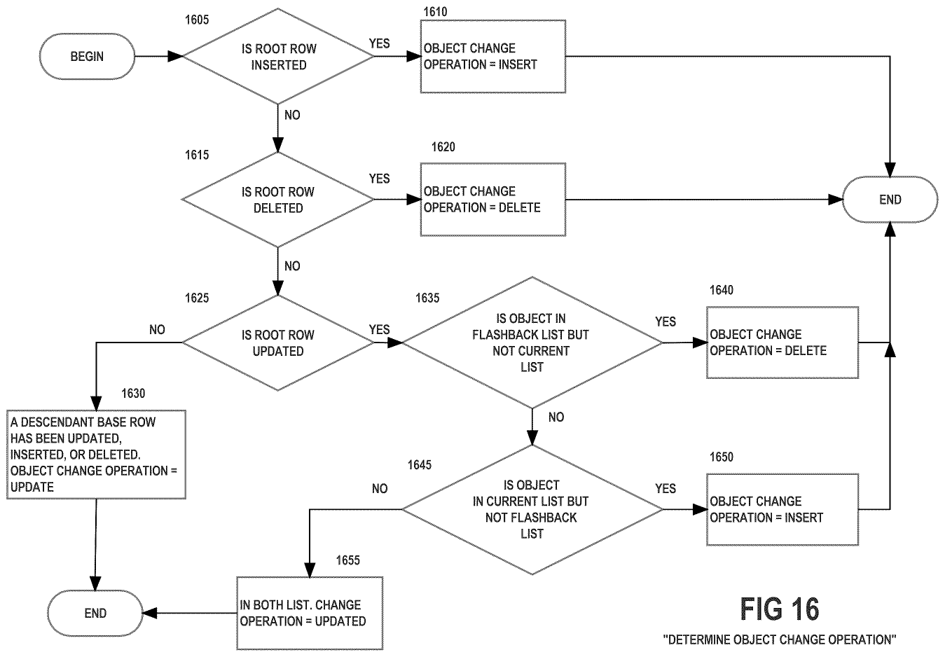

FIG. 16 depicts a procedure performed by a DBMS for determining the object change operation of an affected object. The procedure is used in conjunction with the AOF and the object serialization algorithm that is being executed by a database transaction; the procedure uses data generated therefrom. In particular, from the AOF, the procedure uses the working table-key set, and from the object serialization algorithm, the procedure uses the flashback read mode list and current read mode list, which are referred to here as the flashback mode list and the current mode list.

The procedure relies on checking the working table-key set for an entry for the root row of the affected object. The entry has the primary key of the root row of the root table of the affected object. The primary key of the root row can be derived from the object ID using an object ID translation function.

Referring to FIG. 16, it is determined whether the root row of the affected object is being inserted by the database transaction. (1605) This determination may be made by examining the working table-key set to resolve whether there is an entry for the root row marked INSERT. If the root row has been inserted, then the object change operation is INSERT. (1610)

Otherwise, it is next determined whether the root row of the affected object has been deleted by the database transaction. (1615) This determination may be made by examining the working table-key set to resolve whether there is an entry for the root row marked DELETE. If the root row has been deleted, then the object change operation is DELETED. (1620)

Otherwise, it is next determined whether the root row of the affected object has been updated by the database transaction. (1625) This determination may be made by examining the working table-key set to resolve whether there is an entry for the root row marked UPDATE. If the root row has NOT been updated, then the object change operation is UPDATE, as the affected object is an affected object because of an update, insert, or delete of a descendant base row of the JDV object. (1630)

If the root row has been updated, then the flashback mode list and current mode list are used to determine the object change operation. If the affected object is in the flashback mode list but not in the current mode list (1635) (i.e., affected object deleted by the current database transaction), then the object change operation is DELETE. (1640)

If the affected object is in the current mode list but not in the flashback mode list (1635), then the object change operation is INSERT (1640).

Otherwise, the affected object is in both the flashback mode list and the current mode list. The object change operation is UPDATE. (1655)

### JOURNALING AFFECTED OBJECT TO REPLICATION LOG

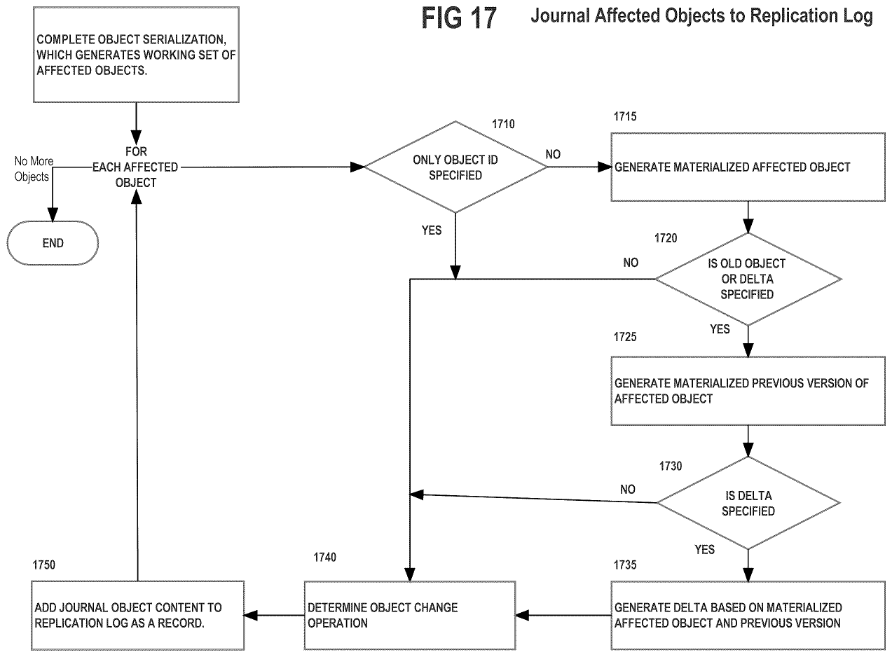

FIG. 17 is a diagram depicting a procedure for journaling affected objects of a database transaction to a replication log. The procedure is performed during commit time.

Referring to FIG. 17, the object serialization algorithm is completed. After the completion, base row lockdown for the affected objects has been achieved, and affected objects in the flashback mode list and the current mode list have been locked in order. The affected objects in the list are herein referred to as the set of working affected objects. Operations 1710 through 1750 are performed to journal each working affected object into the replication log.

First, it is determined whether the notification directive specifies only OBJECT ID for the journal object content. (1710) If not, then operations 1715 through 1735 may be performed to generate other options of journal object content, which are the new version of the JDV object and optionally the previous OLD version, or to store a JSON delta.

Regardless of which of the other options is specified, a new materialized version of the working affected object is generated by executing a JDV construction query against the JSON duality view of the working affected object to return the working affected object. The query is executed in consistent read mode to reflect changes made in the database transaction. (1715) A new version is needed regardless of the remaining options specified for the journal option content.

Next, it is determined whether OLD OBJECT or DELTA is specified for the journal object content. (1720) If so, then the previous version of the working affected object is generated by executing a JDV construction query against the JSON duality view of the working affected object to return a materialized previous version of the working affected object. The query is executed in flashback read mode to reflect the committed state at the completion of the object serialization algorithm for the working affected object. (1725)

Next, it is determined whether DELTA was specified for journal object content. (1730) If so, the JSON delta is generated using the old version and new version of the materialized working affected object as input to a JSON delta generation procedure. (1735)

Before journaling the working affected object, an object change operation is determined for the working affected object using the procedure previously described. (1740).

Finally, the journal object content is added to the replication log as a replication log record. (1750) The object change content stored is as specified for the notification directive for journal object content, the object change content having just been generated by the procedure depicted in FIG. 17.

In an embodiment, the journal object content is generated and stored after committing a database transaction. After committing a database transaction, the commit SCN of the database transaction is known. Thus, the new versions of the object may be generated using flashback queries using, for example, the “AS OF” clause to specify the commit SCN of the database transaction.

### NOTIFICATION DIRECTIVE FOR HISTORY TRACKING

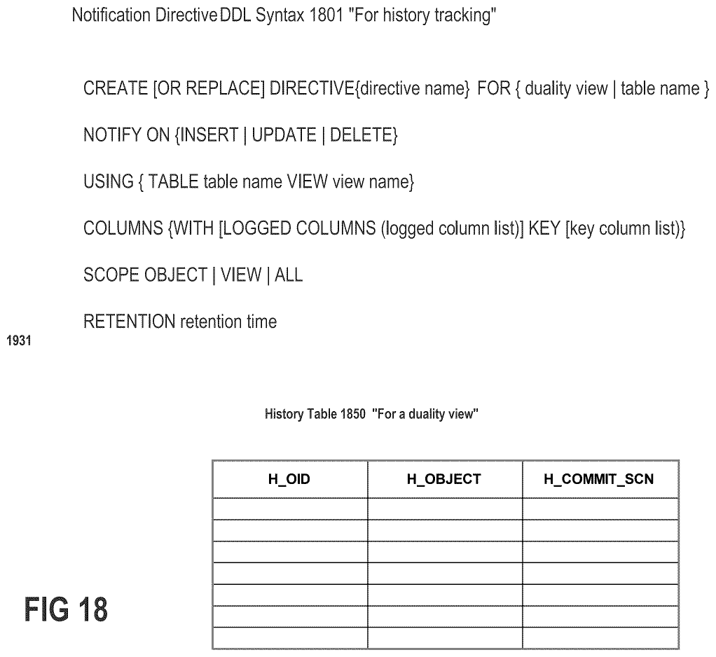

FIG. 18 depicts an illustrative syntax for a notification directive used to define history tracking on a JSON duality view. In an embodiment, a notification directory can also be used to effect history tracking on a database table, but is not fully described herein. However, the syntax for notification directives as it pertains to database tables is described.

Referring to FIG. 18, the DIRECTIVE and FOR clauses take arguments for defining, respectively, the directive name and the duality view or database table for which the directive is defined.

The NOTIFY ON clause specifies one or more on-DML types for which to journal a JDV object, which may be any combination of INSERT, UPDATE, or DELETE. INSERT and DELETE options are limited to DML operations that are object-directed.

The USING clause includes a TABLE clause for specifying the table name of a history table and includes a VIEW clause for specifying a view name for a “history view” for accessing the information in the history table. The VIEW provides a convenient mechanism for accessing the history tracking data that eliminates the need to implement more complex query statements that would otherwise be required, given the complexity and accessibility of a database table implemented for history tracking, as further described below.

The COLUMNS clause is only used for history tracking notification directives for database tables. The WITH clause can be used to specify a logged column list, which specifies a list of columns to track.

The KEY clause is required for a history tracking notification directive. The clause is used to specify one or more key columns in the respective database table that serve as a primary key in the history table. The one or more key columns are typically the primary key of the database table.

The SCOPE clause specifies the scope of the notification directive.

History tracking notification directives are hereafter described with respect to the history tracking of JSON duality view.

### ILLUSTRATIVE HISTORY TABLE FOR JSON DUALITY VIEW

In a history table, each row should store the object change date for a version of the JDV object that is consistent with the transaction commit SCN. The information stored, which may be a delta or a new version of the JDV object, requires the generation of a materialized version of the JDV object. Because of the base row lock provided by the object synchronization algorithm, the committed states of the versions of the base rows used to generate the materialized version of the JDV object by a database transaction will be consistent with its respective transaction commit SCN. The transaction commit SCN may be referred to herein as the object commit SCN with respect to the object change data and/or the materialized version of a JDV object in the row.

Due to complexities regarding the determination and assignment of transaction commit SCNs during the commit phase of a database transaction, a history table is not implemented as a basic database table. However, a history table implemented as a basic database table is described for the purpose of explaining these complexities. Later, an implementation that effectively addresses complexities is described. FIG. 18 depicts a history table for a JSON duality view that is implemented as a simple base database table.

Referring to FIG. 18, History Table 1850 includes columns H_OID, H_OBJECT, and H_COMMIT_SCN. Each row in H_COMMIT_SCN 1850 stores a version of a JDV object journaled by a database transaction according to a notification directive and, in particular, stores the object ID, object change data, and transaction commit SCN of the JDV object in columns H_OID, H_COMMIT_SCN, and H_COMMIT_SCN, respectively. The transaction commit SCN is the transaction commit SCN of the database transaction that journaled a version of a JDV object.

A row is inserted into History Table 1850 by a database transaction by issuing a DML statement directed to History Table 1850. The transaction commit SCN for the database transaction is generated during commit time at a point where no further DML statements can be processed by the database transaction, including a DML statement to insert a row into a history table. Importantly, this restriction means that the H_COMMIT_SCN cannot be updated by the execution of a DML statement after the transaction commit SCN has been determined.

As a consequence, when a row is inserted into the history table, the transaction commit SCN is not known, and thus, the H_COMMIT_SCN column is not yet populated by the insert. It can be asynchronously populated later by another database transaction. However, this leaves open a period of time during which the H_COMMIT_SCN column is not populated. Returning an object change content unassociated with the related transaction commit SCN is inconsistent and can be problematic.

Furthermore, updating the H_COMMIT_SCN column asynchronously creates a transactionally inconsistency that remains even after the column is asynchronously populated. The transaction commit SCN of a database transaction is not only the object commit SCN of the version of the journaled object in a history table row, but also a row commit SCN of the row itself. The later update of H_COMMIT_SCN of the row to populate the row has a later row commit SCN. This leaves open a window of time between the original row commit SCN of the insert and the later row commit SCN in which a committed state of the row has no value for H_COMMIT_SCN. Any database transaction executing a query that reads the changes using a range select query on H_COMMIT_SCN with a flashback SCN that falls within the window of time sees no value in H_COMMIT_SCN.

For example, assume a database transaction that changes a JDV object commits with a transaction commit SCN of 10000. The database transaction journaled the JDV object to History Table 1850, inserting a new row to store the new version of the JDV object using a DML insert statement, which is also committed when the database transaction is committed. Therefore, the insert of the new row in History Table 1850 also has a row commit SCN 10000. Later, the H_COMMIT_SCN in the row is asynchronously updated by a later database transaction to 10000; however, the update itself has a row commit SCN of 11000.

Meanwhile, a database transaction is executing a query having a predicate filter on H_COMMIT_SCN that requires that the column be greater than or equal to 10000. In other words, the query returns journaled objects changed on or after SCN 10000. The snapshot time of the query is 10400. Based on consistent read, the database transaction reads the row based on the committed state of the row as of SCN 10400, which does not include a populated H_COMMIT_SCN. The row is not returned because the unpopulated column does not match the predicate filter, which is an error.

H_COMMIT_SCN is an example of a “commit SCN column”. The SCN in a commit SCN column of a row, in effect, asserts the SCN of the committed state of information in other columns of that row. The information in the other columns is referred to as the payload information; thus SCN value in the commit SCN column of a row should assert the SCN of the committed state of the payload. For a transaction commit SCN column in a row to be valid, for any given committed state of the row, the value in the commit SCN should validly specify the SCN of the committed state of the payload.

In an embodiment, the above-illustrated transactional consistency for the transaction commit SCN column H_COMMIT_SCN is overcome by populating a transaction commit SCN column atomically with the commit of the database transaction through a new mechanism described below. However, before describing the mechanism, it is useful to describe how a database transaction is atomically committed.

Finally, there may be embodiments that modify more than one commit SCN log. For example, there may be a commit SCN log for each set of multiple sets of history tables. Commit patching may involve recording changes to multiple data blocks of respective commit SCN logs. While this may entail more overhead than needing to only modify one data block of one commit SCN log during commit patching, such overhead may be far less than having to record changes to multiple rows of one or more history tables.

### ATOMICALLY COMMITTING TRANSACTIONS

Database data for database tables is stored in data blocks. Updating, inserting, or deleting a row in a database table entails modifying a data block that stores the row. To modify the row, the data block is read into a database buffer in memory and then modified. A redo record is generated within a log buffer to record the modification. The redo record is written persistently to a persistent log. A database transaction does not commit until all the redo records recording the changes made by the database transaction to rows in data blocks are stored persistently in the persistent log. A database transaction may change many data blocks in multiple tables and generate many redo records. The database transaction is committed atomically by writing and persisting a single redo record for a single data block, as described below.

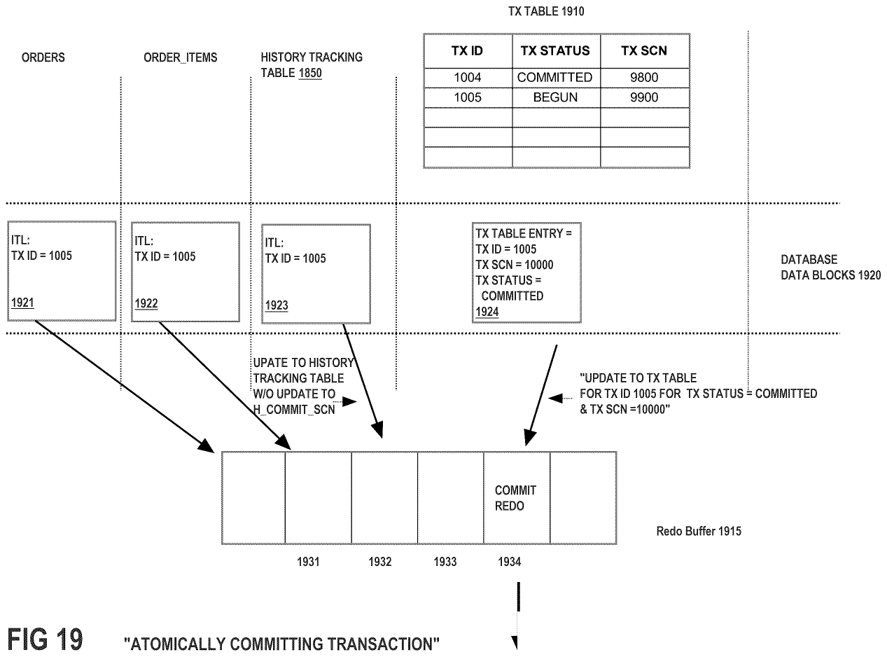

FIG. 19 depicts data blocks and a redo buffer used to illustrate how a database transaction is atomically committed. Atomically committing a database transaction also uses a transaction table that tracks the status of database transactions and SCNs associated with the database transactions, such as the begin SCN and transaction commit SCN.

Referring to FIG. 19, TX table 1910 is a system table used to track and manage database transactions executed within a DBMS. TX table 1910 includes three columns, TX ID, TX STATUS, and TX SCN, which hold transaction IDs, transaction statuses, and SCNs. Each entry, which holds a database transaction ID of a database transaction, stores the transaction status and the transaction commit SCN of the database transaction; the semantics of the SCN depend on the transaction status of the database transaction. For example, for the entry with transaction ID 1004, the transaction status is COMMITTED. Therefore, the SCN in the column TX SCN is the transaction commit SCN=9800 of database transaction 1004. For the entry with transaction ID 1005, the transaction status is BEGUN, and therefore, the SCN in TX SCN is beginning SCN=9900 of database transaction 1005.

Database data blocks 1920 include data blocks that store rows for tables ORDERS, ORDER_ITEM, and History Table 1850. For purposes of illustration, these data blocks are stored in a database buffer so that database transaction 1005 can make changes to these data blocks. The changes are not yet committed; accordingly, the transaction status for database transaction 1005 in TX STATUS is BEGUN. Similar to data blocks for database tables, entries for TX table 1910 are also stored in data blocks, which may also be stored in an in-memory buffer.

To update a JDV object in ORDERS_OV, database transaction 1005 is changing data blocks 1921, 1922, and 1923, which store data for ORDERS, ORDER_ITEM, and History Table 1850, respectively. The changes to these data blocks are recorded in redo records 1931, 1932, and 1933 in redo buffer 1915. In addition, the data blocks store transaction metadata, which includes an interested transaction list (ITL), which lists database transactions that are potentially modifying the data block. Each of data blocks 1921, 1922, and 1923 includes database transaction ID 1005 in their respective ITLs.

The update to a row in data block 1922 of the History Table 1850 includes column data such as object change data. However, the update does not include a transaction commit SCN for column H_COMMIT_SCN. The transaction commit SCN is not yet assigned to the database transaction. Thus, redo record 1933 does not include an update to this column.

Before database transaction 1005 is committed, the transaction status remains BEGUN. When another database transaction executes a query with a snapshot time of 9950, the database transaction reads, for example, data block 1922. To determine whether the data block may be read for consistent read purposes, the database transaction examines the ITL of data block 1922 to resolve any listed database transactions. The database transaction determines that the ITL includes transaction ID=1005. In response to this determination, the database transaction looks up the transaction status in TX table 1910 and determines that the transaction status is BEGUN, meaning that database transaction 1005 is not committed and that data block 1922 may reflect changes made by uncommitted database transaction 1005. In response to determining that the database transaction is not committed, the other database transaction performs consistent read operations, which may include creating a consistent read version of data block 1922 by rolling back changes made by database transaction 1005.

As shown above, for a data block, an ITL entry's transaction ID serves as a reference to look up the status of a database transaction that may be changing the data block. Each data block being changed by a database transaction includes an entry in the ITL that refers to the status of the database transaction in this way.

To commit a database transaction, the TX STATUS in the entry for the database transaction in TX TABLE 1910 is changed to COMMIT, and the TX SCN is set to the transaction commit SCN of the database transaction. Only this entry needs to be changed in this way to record the fact that a database transaction is committed because any database transaction accessing the database block examines this entry. None of the data blocks changed by the database transaction need to be changed to reflect that the changes have been committed.

Before changing the entry in TX TABLE 1910, redo records that are generated in the redo buffer by the database transaction must be persisted in the persistent redo log. Afterward, a “commit redo record” recording the change to the database transaction's entry in TX TABLE 1910 is persisted in the redo log. Thus, all the redo records recording changes to data blocks made by a database transaction are persisted to the persistent redo log before the commit redo record is persisted.

In the current example, in the entry for database transaction 1005, TX STATUS is changed to COMMITTED, and TX SCN is changed to the transaction commit SCN of 10000. The entry is stored in data block 1924. The change to this data block is recorded in commit redo record 1924 for database transaction 1005, similar to the way a redo record records a change to a data block for a database table.

A database transaction is not treated as committed before the commit record that records the change to the data block storing the transaction status in TX STATUS, and the transaction commit SCN in TX SCN is persisted in the persistent redo log. In this way, a database transaction is atomically committed by persisting the commit redo record that records a change to a data block.

### TRANSACTION COMMIT SCN PATCHING

To resolve any transaction inconsistency that arises by asynchronously updating a transaction commit SCN column, the transaction commit SCN column is updated separately from other columns in the table at the very end of commit processing. Specifically, the transaction commit SCN column is updated along with TX TABLE at commit time after the transaction commit SCN for a database transaction has been assigned. The commit redo record not only records the change to the TX table but also to the transaction commit SCN column of the history table. Thus, the commit redo record stores changes to multiple data blocks. Updating a transaction commit SCN column in this way is referred to as transaction commit SCN patching.

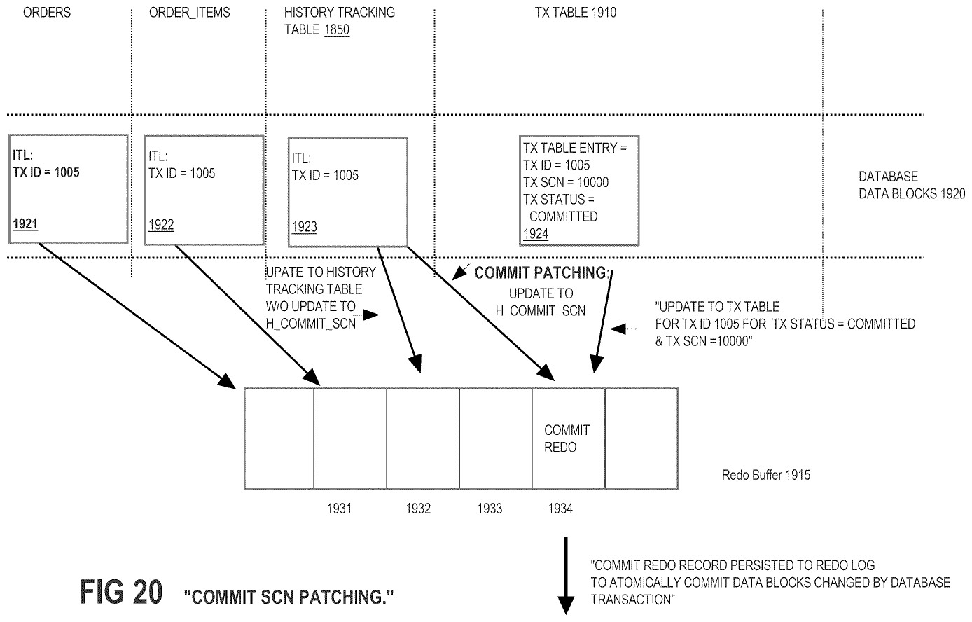

FIG. 20 depicts the commit of a database transaction, as augmented with commit patching. As before, History Table 1850 is updated without inserting a value into H_COMMIT_SCN. However, H_COMMIT_SCN is updated in conjunction with changing the entry for database transaction 1005 in TX TABLE 1910. The changes modify blocks 1923 and 1924, respectively. The changes to data blocks 1923 and 1924 are recorded in commit redo record 1934. Once commit redo record 1934 is persisted, database transaction 1005 is committed.

Commit patching has been illustrated in the context of a history table defined for a history tracking notification for a JSON duality view. However, commit patching may be used with any database table that has a transaction commit SCN column.

### STREAMLINED COMMIT PATCHING FOR MULTIPLE TABLES

In general, each duality view for which a history tracking notification is defined will have a corresponding separate history table. A database transaction may journal JDV objects to multiple history tables. If each history table has a transaction commit SCN column, then transaction commit SCN patching could be implemented by recording updates to the transaction commit SCN column of each history table in the commit redo record, which would require recording changes to multiple data blocks of multiple history tables. However, there is an undesirable overhead to recording changes to many data blocks in a single commit redo record may record changes.

To address this overhead, the transaction commit SCN column is, in effect, normalized across history tables by storing transaction commit SCNs in a single transaction commit SCN column in a single table, referred to as a commit SCN log. The commit SCN log can be joined with a history tracking table to associate each row in the history table with a transaction commit SCN. The commit SCN log includes as a primary key a column that stores database transaction IDs. The database transaction IDs serve as foreign key values for the history tables. Under this scheme, only a row with a transaction commit SCN column in the commit SCN log table needs to be inserted by transaction commit SCN patching, and a redo commit record needs only to record a transaction commit SCN column change in the one data block that holds the row.

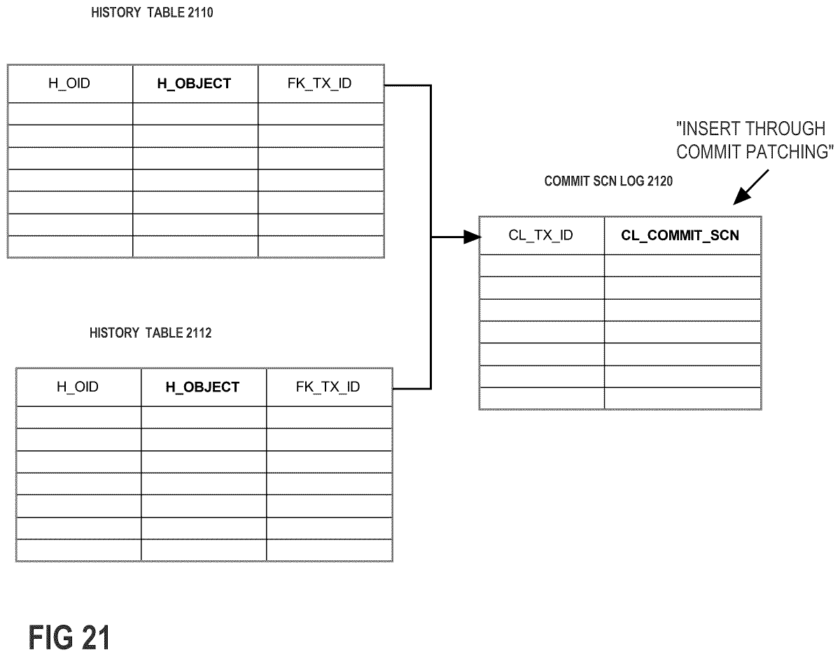

FIG. 21 depicts commit SCN log 2120, which includes columns CL_TX_ID and CL_COMMIT_SCN. Column CL_TX_ID holds database transaction IDs and is a primary key. CL_COMMIT_SCN is a transaction commit SCN column. History tables 2110 and 2112 are similar to History Table 1850, except that they include FK_TX_ID in lieu of H_COMMIT_SCN. FK_TX_ID is a foreign key based on the primary key CL_TX_ID and stores database transaction IDs as foreign key values.

When a row is inserted into the history table 2110 and 2112 by a database transaction applying a notification directive, the insert includes the database transaction ID of the database transaction. When the database transaction performs commit patching, a row is inserted into commit SCN log 2120 having a database transaction ID and transaction commit SCN for columns CL_TX_ID and CL_COMMIT_SCN, respectively.

Querying a history table that filters rows based on transaction commit SCNs involves joining a history table with a commit SCN log. In addition, a history table and commit SCN log are system tables that are normally not visible to end users. To provide end-user access to information in a history table and to facilitate the design of queries based on transaction commit SCN columns, a history view joins the history table and commit SCN log and projects columns from each, including object change data and the transaction commit SCN column of the commit SCN log. The latest object commit SCN can be retrieved using a query. For example, the “select max(cl_commit_scn) from history_view where h_oid=:my_object_id returns the most recent SCN on the referenced JDV object.

### COMMIT LOG PARTITIONING

To accelerate queries that access a history table that filters rows based on the transaction commit SCN column of the commit SCN log, the transaction commit SCN column may be indexed. However, inserting or updating an indexed column may entail modifying a data block that stores the index. An SCN is a monotonically increasing number that will cause “right growing” in an index, where consecutive changes to the index concentrate access on the same “hot” data block. As a consequence, many database transactions adding a key value to the index contend for the same data block, which can delay the commit patching. Furthermore, adding a new key value to an index may trigger a data block split operation to allow the index to grow. This means a commit redo record may have to record changes to even more data blocks, which leads to even more overhead.

To facilitate indexing in a way that minimizes or eliminates problems attendant to modifying an indexed column during commit patching, the commit SCN log and history tables are partitioned. In partitioning, a table is split into multiple partitions that are stored in respective sets of data blocks.

According to an embodiment of the present invention, a commit SCN log is partitioned into multiple partitions. Commit patching uses only one of the partitions (“active partition”) for commit patching operations and, in particular, only modifies the portion of the commit SCN log stored in the active partition. Eventually, commit patching operations stop using the active partition and start using another partition as the active partition. In this way, inserts are directed to the active partition. In response to an active partition being replaced with another active partition, the partition is indexed. Hence, the partitions other than the active partition are indexed.

### PARTITIONING

A table may be partitioned based on a partition key and a variety of partitioning techniques as follows. Under range partitioning, a partition is associated with one or more distinct ranges of partition key values. When a row having a partition key value is inserted, it is inserted into the partition that is associated with the range into which the partition key value falls. Under list partitioning, partitions are each associated with a value. When a row having a partition key value is inserted, it is inserted into the partition that is associated with that list of values to which the partition key value belongs. When a row having a partition key value is inserted, it is inserted into the partition that is associated with the partition key value. Under system partitioning, a DML command that inserts or updates a row identifies the partition to which the row belongs. The DBMS either inserts into the identified partition or moves the row there in the case of an update that changes the partition of a row. Under hash partitioning, rows are distributed across partitions according to a hash scheme.

Partitioning can exploit partitioned table families. A partition table family comprises database tables that are related based on a FK:PK relationship. A child table in a family is a table that has a FK:PK relationship with a parent table.

In partitioned table families, all of the child tables of a table family are partitioned by inheriting the partitioning key from the parent table of the table family. For each partition of a parent table, there is a corresponding partition for the child table that is partitioned by the inherited parent key. A partition of the parent table is referred to as a parent partition, and the partition of the child table is referred to as a child partition; the parent partition and its corresponding child partition are referred to as parent and child with respect to each other and referred to together as a partitioned table subfamily. Finally, the partition key of the parent table is used as the partition key for all tables in the table family.

### COMMIT SCN LOG PARTITION FAMILY

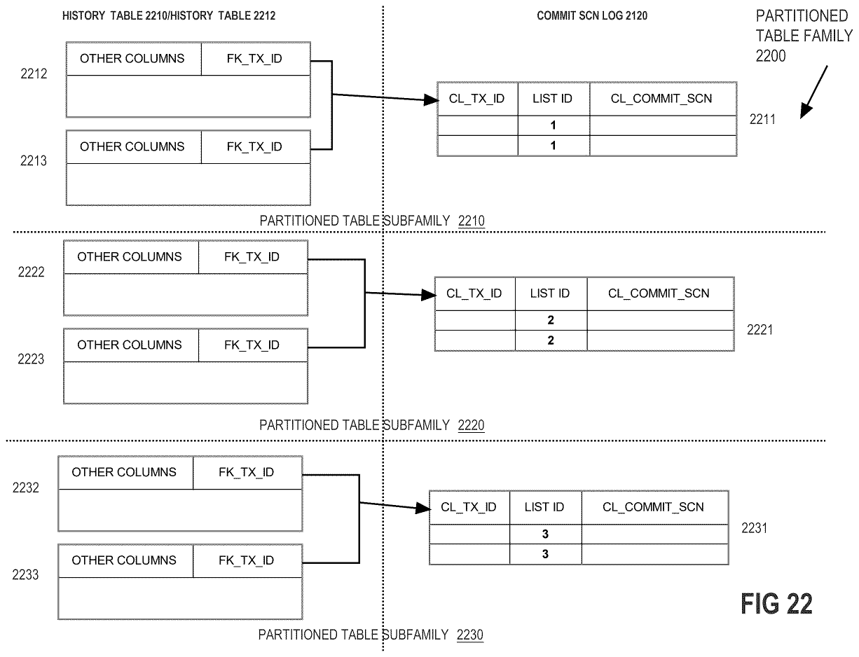

FIG. 22 shows a partitioned table family 2200 for commit SCN log 2120 and history tables 2112 and 2110. Commit SCN log 2120 includes column LIST ID, which is used as a partition key for list partitioning. Commit SCN log 2120 is the parent table of partitioned table family 2200. As such, LIST ID is the inherited partition key for history tables 2110 and 2112. In an embodiment, list partitioning is used because of limitations regarding the stage at which commit patching is performed at commit time. However, an embodiment is not limited to list partitioning; other forms of partitioning may be used.

FIG. 22 depicts partitioned table subfamilies 2210, 2220, and 2230, which include, respectively, (1) parent partition 2211 of commit SCN log 2120 and child partitions of 2212 and 2213 of history tables 2110 and 2120, respectively, (2) parent partition 2221 of commit SCN log 2120 and child partitions of 2222 and 2223 of history tables 2110 and 2120, respectively, and (3) parent partition 2131 of commit SCN log 2120 and child partitions 2232 and 2233 of history tables 2110 and 2120, respectively.

The partition key values in LIST ID that are associated with each of the partitioned table subfamilies 2210, 2220, and 2230 are 1, 2, and 3, respectively. Each row in history tables 2110 and 2112 has a foreign key value (i.e., database transaction ID) matching a row in a parent partition of commit SCN log 2110 and is in a respective child partition for the parent partition. When a row is inserted into either of history tables 2110 and 2112, the row is inserted into the child partition of the parent partition having the row with the primary key value matching the foreign key value of the row being inserted, that is, with matching database transaction IDs in the respective foreign and primary keys.

At any given point in time, a parent table partition of a commit SCN log 2120 is active. This feature is accomplished in part by defining a default value for LIST ID. A row is inserted in commit SCN log 2120 without specifying a value for LIST ID. Inserting rows in this way triggers the DBMS to populate LIST ID with the default value. The default value for LIST ID, in effect, establishes the active parent partition and “active” partitioned table subfamily. Rows inserted into the history tables 2110 and 2120 by a database transaction have a database transaction ID for their respective foreign key FH_YX_ID that matches the primary key CL_TX_ID of the row inserted into commit SCN log 2120 by the database transaction. As a result, the rows are inserted into the child partitions of the active parent partition and active partitioned table subfamily.

In an embodiment, system partitioning may be used. A DML insert operation that inserts a row into a history table identifies an active child partition for the change tracking table. Similarly, an insert operation of a row into the commit SCN log identifies the active partition of the commit SCN log

### ACTIVE PARTITION SUCCESSION

The operation of replacing an active partitioned table family with a new active partitioned table subfamily is referred to herein as active partition succession. Once replaced, the former active partition of the commit SCN log table is indexed. A procedure for active-partition succession shall be later described.

There are various factors pertinent to scheduling active-partition succession. One factor is the targeted degree of indexing. The shorter the interval between active-partition succession, the greater the proportion of the commit SCN log that is indexed and that may be accessed more efficiently. Another factor is storage space. Partitioned table subfamilies or a parent partition of the commit SCN log are assigned a threshold amount of storage to facilitate, for example, archiving or retention. Smaller thresholds allow archiving and retention to be performed with a finer degree of granularity.

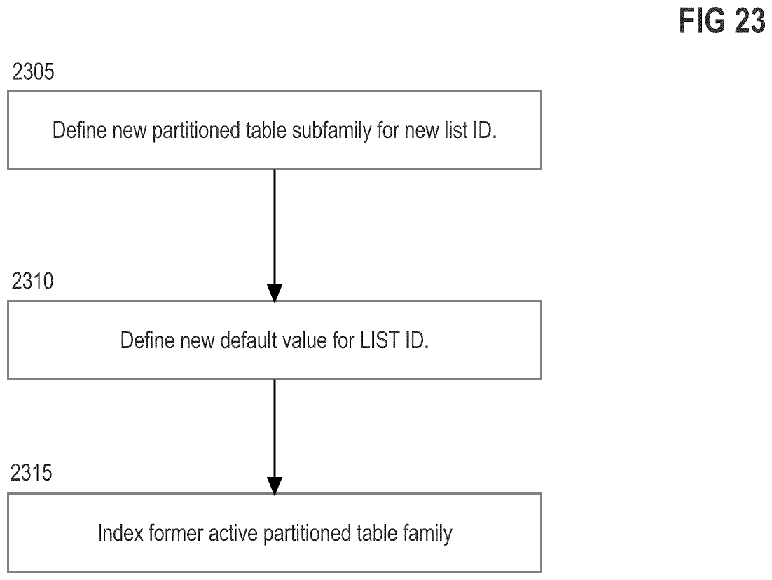

FIG. 23 depicts a procedure for active-partition succession. The procedure may be scheduled based on the factors discussed above. For example, the procedure may be performed in response to detecting that the active partitioned table family is about to fill the storage space allotted to the partitioned table family.

Referring to FIG. 23, a new partitioned-table family is defined using list partitioning. (2305) A new partition key value for the LIST ID column is assigned to the parent partition of the new partitioned table family. A partitioned table family is defined by issuing a DDL command to the DBMS. The DDL command may specify tablespaces and/or storage segments to use to store database table data for the partitioned table family.

Next, the default value for column LIST ID of commit SCN log 2120 is set to the new partition key value (2310). Setting this default deactivates the current active partitioned table subfamily and activates the new partitioned table subfamily as the active partitioned table subfamily. In this way, inserts to commit SCN log 2120 are directed into the new active partitioned table subfamily. Thus, henceforth, rows inserted into history tables 2112 and 2110 and commit SCN log 2120 are inserted into the new active partitioned table subfamily.

If system partitioning is used, insert operations to history tables 2112 and 2110, and commit SCN log 2120 specify the respective partitions of the new partition table subfamily.

Finally, the deactivated partition of commit SCN log 2120 is indexed by CL_COMMIT_SCN. (2315)

Because the active partition of commit SCN log 2120 is not indexed, queries that filter based on CL_COMMIT_SCN may scan the entirety of the active partition of the commit SCN log 2120 when none of the rows therein satisfy the filter predicate. A measure to ameliorate such scenarios is zone maps. Zone maps store information about the minimum and maximum values of a column stored in a set of data blocks. The set of data blocks may be an extent, which is a set of data blocks stored contiguously within an address space. The set of data blocks may be a partition and/or segment, which comprises one or more extents. The minimum and maximum values may be used to exclude (prune) a set of data blocks from scanning based on the minimum and maximum values. If no value between the minimum and maximum value inclusively can satisfy the filter predicate, then the set of data blocks may be excluded from table scanning because no row therein could satisfy the predicate value. Zone maps may be based on minimum and maximum commit SCNs stored in column CL_COMMIT_SCN. Such zone maps would enable pruning for scans of the active partition that filter on CL_COMMIT_SCN.

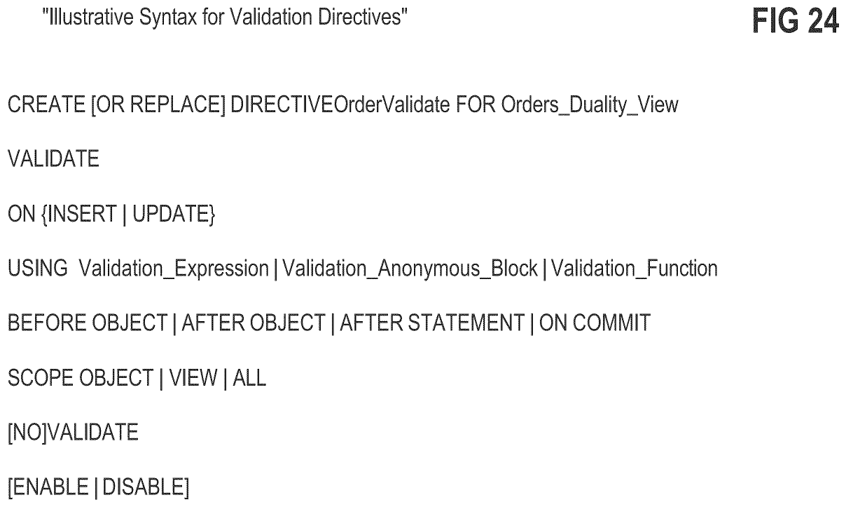

FIG. 24 depicts an illustrative syntax for DDL statements that are used to define validation directives. A description of the syntax also serves as an introduction to validation directives.

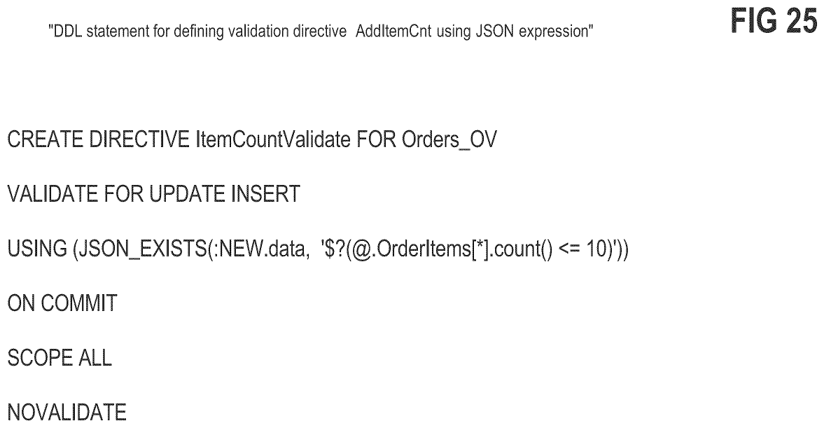

Referring to FIG. 25, the DIRECTIVE and FOR clauses take arguments for defining, respectively, the validation directive name and the duality view or database table for which the validation directive is defined.

The ON clause specifies the on-DML type for the directive. According to an embodiment, one or more on-DML types may be specified.

The key phrases BEFORE OBJECT, AFTER OBJECT, AFTER STATEMENT, and ON COMMIT specify the directive application time for a validation directive. When the directive application time defined for a validation directive is BEFORE OBJECT and AFTER OBJECT, the validation directive is only evaluated for DML statements that are object-directed. The BEFORE OBJECT keyword specifies to apply a validation directive before changing a JDV object, and the AFTER OBJECT after changing the object.

The USING clause defines a “validation expression” or “validation function” used for validation. A function may be an anonymous function or a named function to call that is defined by the DBMS. In the case of an anonymous function, the USING clause includes the argument Augmentation_Anonymous_Block, which is an anonymous function implementation. The validation expression or validation function returns TRUE or FALSE or the equivalent to indicate whether a validation directive is satisfied. When a validation directive is not satisfied, an exception is thrown to signal that an error was encountered when executing a DML statement, or in the case where the directive application time is ON COMMIT, the commit of the database transaction throws an exception, and commit processing ceases.

The SCOPE clause specifies the scope of the validation directive. No SCOPE can be specified when the directive application time is BEFORE or AFTER OBJECT.

The VALIDATE and NO VALIDATE keywords specify whether or not, respectively, to evaluate the validation directive against all JDV objects of the JSON duality view in response to issuing the DDL statement. If, during the evaluation, a JDV object is encountered that does not satisfy the validation direction, an exception error is thrown.

### ILLUSTRATIVE VALIDATION DIRECTIVES

FIG. 25 depicts a DDL statement defining a validation directive, ItemCountValidate on ORDERS_OV that uses a JSON expression for validation. The validation directive determines whether the count of line items in order is 10 or less. The JSON expression is a json_exists function that accepts as an argument NEW. data and the JSON path expression “$?(@.OrderItems[*].count()<=10)”. The JSON path expression is evaluated by the json_exists function against NEW.data. Similar to an augmentation directive, the NEW.data is a reference to an in-memory copy of a JDV object reflecting any modification made to it by the database transaction within which the validation directive is evaluated.

Evaluation of the path expression determines a count of entries in the JSON field array OderItems. If 10 or fewer, the json_exists returns TRUE. Otherwise, false is returned.

The ON clause specifies the on-DML type. The ON COMMIT key phrase specifies the directive application time, and the SCOPE clause specifies that the scope is ALL. Hence, the validation directive will be evaluated against directly or indirectly modified affect objects at commit time for INSERT and UPDATE DML statements.

Because NOVALIDATE is specified for ItemCountValidate, JDV objects belonging to ORDERS_OV are not validated in response to the DDL statement being issued to a DBMS.

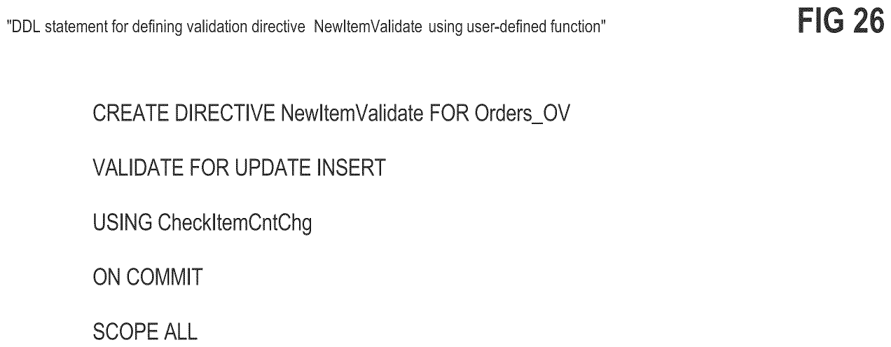

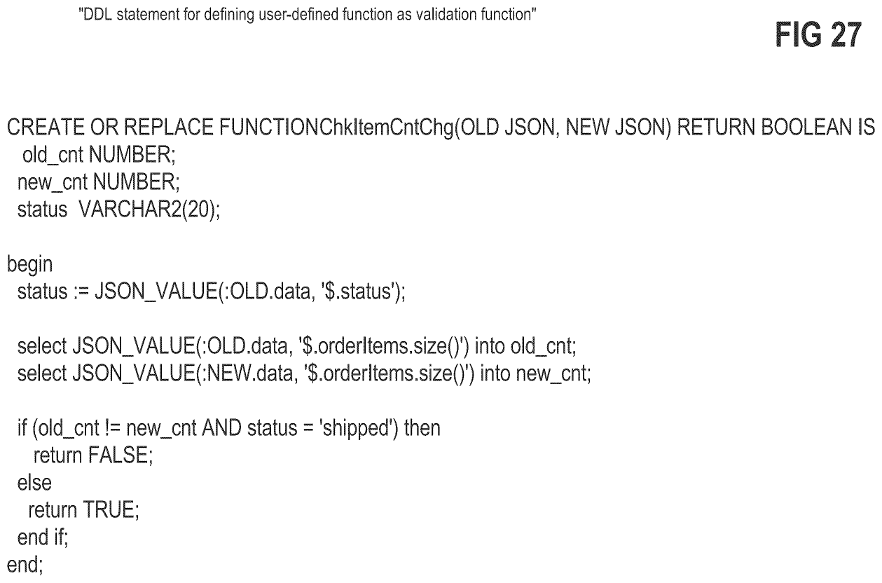

FIG. 26 depicts a DDL statement that defines a validation directive, NewItemValidate, that calls a user-defined validation function ChkItemCntChg. FIG. 27 depicts a DDL statement that defines the validation function ChkItemCntChg.

Referring to FIG. 26, the DDL statement defines a validation directive for duality view ORDERS_OV. The ON clause specifies on-DML types UPDATE and INSERT. The directive application time for ItemCountValidate is ON COMMIT, and the scope is ALL. Hence, the validation directive will be evaluated against directly or indirectly modified affect objects at commit time for UPDATE and INSERT DML statements.

The USING clause defines ChkItemCntChg as the validation function to call. The function determines whether the item count and old item count differ, and if so, and the order has shipped, an error is raised. No items should be added or removed after shipment.

FIG. 27 depicts a DDL statement defining the function ChkItemCntChg having a return type of BOOLEAN. As with function implementations that may be defined for augmentation directives, a user-defined validation function implementation may reference variables that refer to NEW.data and OLD.data.

In general, a validation function may only reference data within the bounds of the JDV object. The select statements within the implementation of ChkItemCntChg reference only data within the bounds of the JDV object, i.e., data contained in NEW.data and OLD.data. Data in augmented fields is data within the bounds of an object.

### DUALITY VIEW CONSTRAINTS

Duality view constraints (check constraints) are validation directives that are declared within a DDL duality view definition. Like validation directives, a duality view check constraint requires a name. The name must differ from that of any other used for a check constraint or validation directive defined for the duality view. The definition of the check constraint may specify an on-DML check constraint for which the constraint is evaluated. A SCOPE can be explicitly defined.

Check constraints are defined and applied similarly to the way validation directives are applied. Like a USING clause for a validation directive, a duality view constraint includes a CHECK clause expression, which can be a JSON expression such as a path-based JSON function like json_exists. The JSON expression should return a BOOLEAN value.

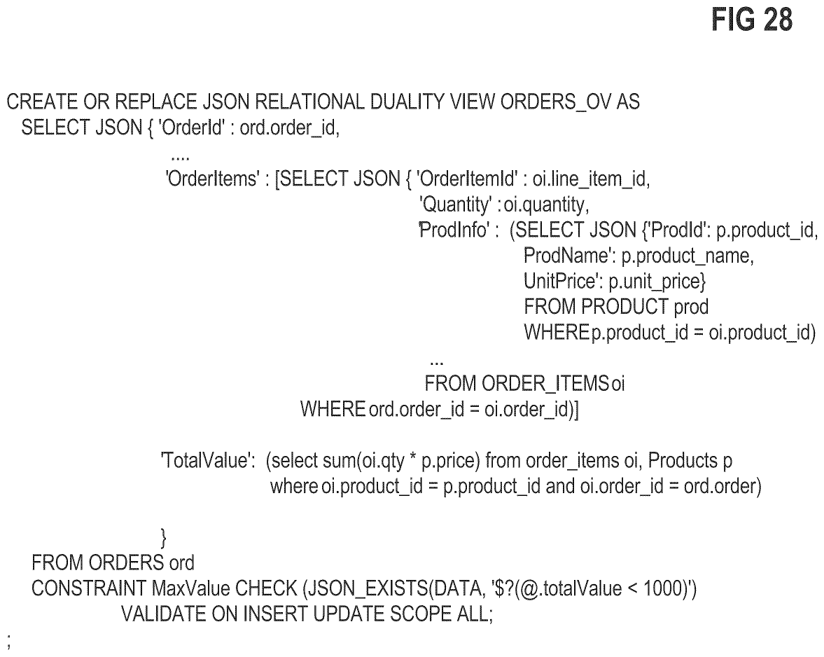

FIG. 28 depicts a DDL statement defining a version of ORDERS_OV that has a check constraint MaxValue. A check constraint declaration follows the main constructor query and begins with a CONSTRAINT clause that includes an argument for the check constraint name, followed by a CHECK clause expression. The expression may refer to fields defined in the query constructor, including an augmented field, as depicted in FIG. 28.

The ability to refer to augmented fields increases the power and complexity of the validation that can be performed for a check constraint. The path-based expression of the check constraint MaxValue refers to the augmented field TotalValue, which itself is defined by a constructor subquery. In this way, check constraints can be applied based on aggregated field values within a JDV object.

The declaration of MaxValue also specifies SCOPE ALL and an on-DML type, which are INSERT and UPDATE.

### BEFORE/AFTER OBJECT VALIDATION

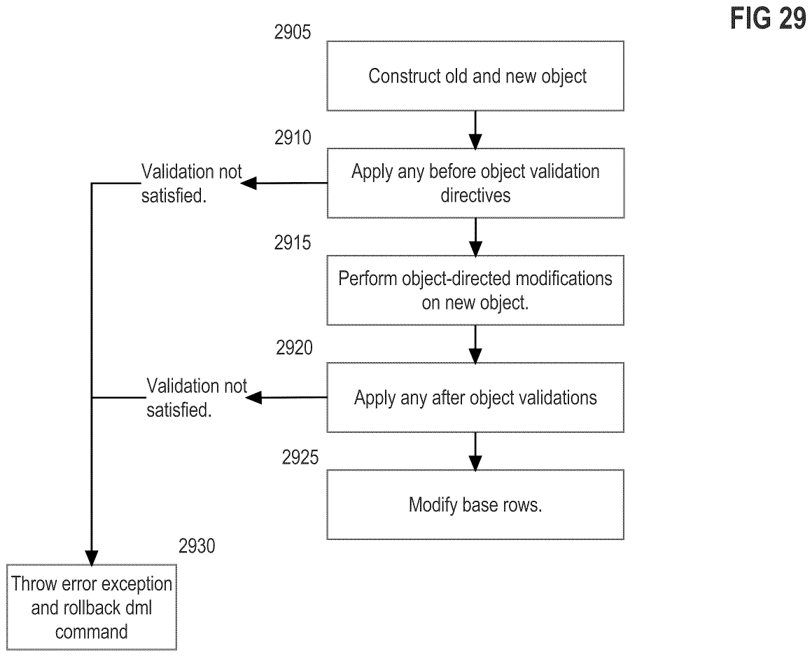

FIG. 29 depicts a procedure for performing validation directives having an application directive time of BEFORE OBJECT and/or AFTER OBJECT. The procedure is performed for a DML statement that is object-directed. Multiple JDV objects may be affected by a single DML statement. The procedure is performed on each JDV object until a validation error is encountered. The JDV object for the procedure being performed is referred to as the current JDV object, and the duality view to which the JDV object belongs is referred to as the current JDV object.

A validation error is referred to as occurring when a validation directive is evaluated against a JDV object, and the evaluation determines that the JDV object does not satisfy the validation directive. In general, once a validation error is encountered for a JDV object, an error exception is thrown, the database statement is rolled back, and execution of the DML statement ceases.

An old JDV object and a new JDV object are constructed for the current JDV object, as depicted in FIG. 9. (2905) As explained before, the old JDV object and new JDV object are in-memory versions of the current JDV object, as augmented by augmentation directives or inline augmentations defined for the current duality view. At this stage, the old JDV object and the new JDV object are identical.

Next, any BEFORE OBJECT validation directives defined for the current duality view are applied. (2910) If a validation error is encountered for a validation directive, then an error exception is thrown, the DML statement is rolled back, and execution of the DML statement ceases. (2930)

Next object-directed modifications specified by the DML statement are applied to the new JDV object. (2915)

Next, any AFTER OBJECT validation directives defined for the current duality view are applied. (2910) If a validation error is encountered for a validation directive, then an error exception is thrown, the DML statement is rolled back, and execution of the DML statement ceases. (2930)

Finally, any base rows of the current JDV object that should be modified to reflect the object-directed changes are modified. The base rows to modify are derived from differences between the old JDV object and the new JDV object.

### AFFECTED OBJECT FRAMEWORK FOR DIFFERENT TYPES OF DIRECTIVES AND DIRECTIVE APPLICATION TIME

A database statement may update base tables of duality views that have both validation and notification directives, which may have different directive application times. Thus, during execution of a database transaction, a set of affected validation directives may be applied at the end of executing a database statement, another set of affected validation directives may be applied at commit time, and yet another set of affected notification directives may also be applied at commit time. These are referred to respectively as the set of statement affected validation directives, the set of commit affected validation directives, and the set of commit notification directives. Each of these sets of directives may be applied to a separate set of affected objects and use a separate set of view-path lists to generate the separate set of affected objects. The separate set of view-path lists is respectively referred to as a statement validation view-path list, a commit validation view-path list, and a notification view-path list.

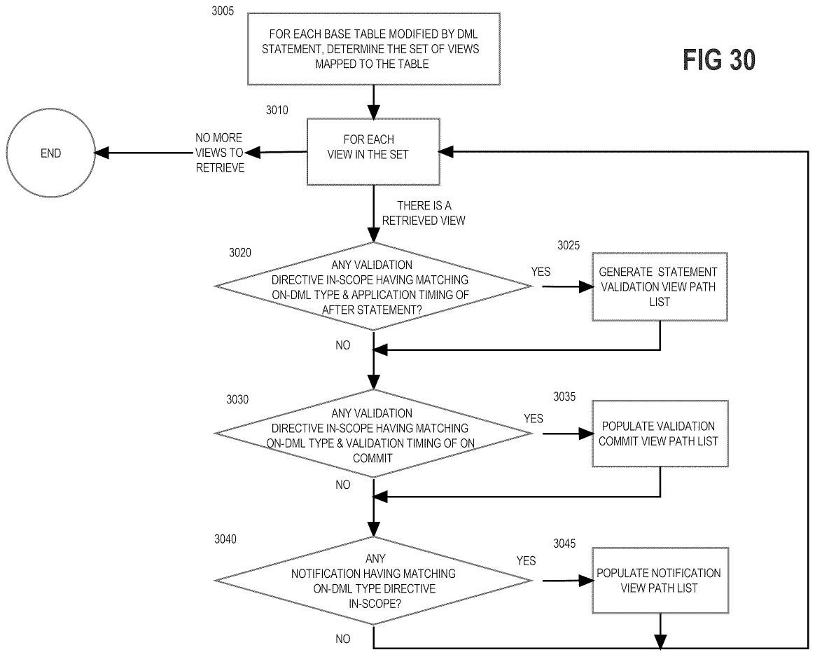

FIG. 30 depicts a procedure that can generate separate affected view-path lists during compile time under AOF. The procedure is executed by a DBMS compiling a database statement.

Referring to FIG. 30, for each base table modified by the database statement, the set of JSON duality views mapped to the base table is determined. (3005) For each JSON duality view (3010), herein referred to as the current view, a set of three determinations is made that may trigger the generation and/or population of an affected path-list.

The DBMS determines whether there are validation directives defined for the current view that satisfy the following criteria: (1) the validation directive is in-scope, (2) the directive application time is AFTER STATEMENT, and (3) the on-DML type matches the type of the DML statement. (3020) An on-DML type of INSERT is matched by an INSERT database statement; an on-DML type of UPDATE is matched by an UPDATE statement.

As described earlier, whether a directive is in scope for a database statement depends on the defined scope for the directive and whether the DML statement is object-directed or table-directed. If object-directed against the JSON duality view in the DML statement, the defined scope of the directive is VIEW, and the current view is the same as the JSON duality view in the DML statement, then the validation directive is in scope. If the defined scope is ALL, then the directive is in scope.

In response to determining that any of the validation directives defined for the current view satisfy the above criteria, a statement validation view-path list is populated with the dependency mappings of the current view. (3025)

Second, the DBMS determines whether there are validation directives defined for the current view that satisfy the following criteria: (1) the validation directive is in-scope, (2) the directive application time is ON COMMIT, and (3) the on-DML type matches the type of the DML statement. (3030)

In response to determining that any of the validation directives defined for the current view satisfy the above criteria mentioned for 3030, a commit validation view-path list is populated with the dependency mappings of the current view. (3035)

Third, the DBMS determines whether there are any notification directives defined that are in-scope and that have an on-DML type that matches the type of the DML statement. In an embodiment, a notification directive can only have a directive application time of AT COMMIT. Hence, this determination does not use criteria based on directive application time. (3040)

Each notification directive defined that has been determined to be in-scope and that has an on-DML type that matches the type of the DML statement is a commit-affected notification directive. In response to determining that there are any commit affected notification directives, a notification view-path list is populated with the dependency mappings of the respective views of the set of commit affected notification directives, similar to as previously described. (3045)

### AFTER STATEMENT AND AT COMMIT VALIDATION

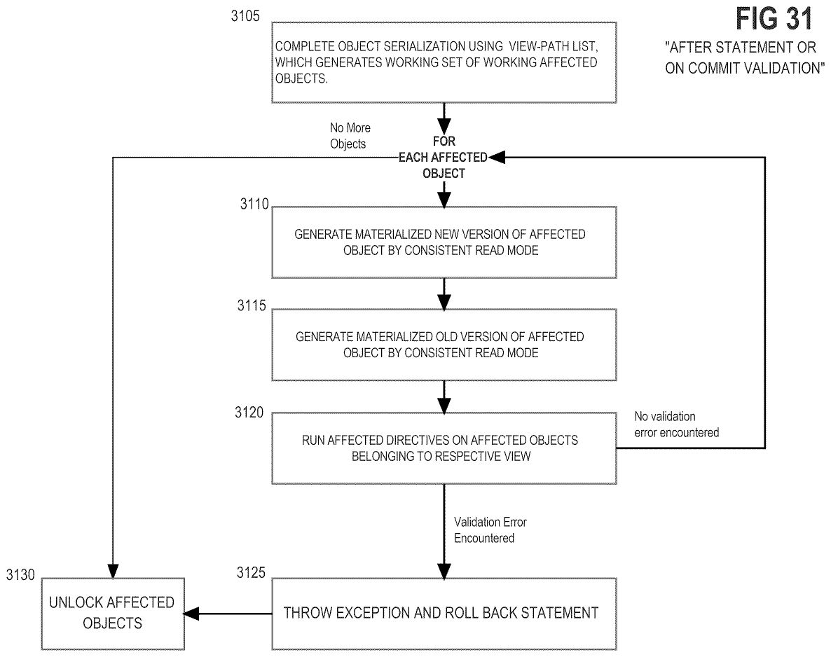

FIG. 31 depicts a procedure for performing validation at a directive application time. The procedure applies a set of working validation directives. If the directive application time is AFTER STATEMENT, the working validation directives are the statement's affected validation directives. If the directive application is ON COMMIT, the working validation directives are the commit-affected validation directives.

The procedure is performed in the context of a database transaction that is executing a database statement. The database system is compiled and executed according to AOF. In general, a database statement is run in response to a call issued in a database transaction by a database client.

The procedure materializes versions of affected objects that are transactionally consistent. To achieve transactional consistency, the procedure runs the object serialization algorithm before applying validation directives.

Referring to FIG. 31, the object serialization algorithm is run using the working validation view-path list to generate the set of working affected objects for the object serialization algorithm. (3105) The object serialization algorithm locks the set of working affected objects. Afterward, for each working affected object in the set, a new and old materialized version of the working affected object (i.e., new JDV object and old JDV object) is generated, which may be used by commit affected validation directives until a validation error is encountered, if any.

Referring to FIG. 31, operations 3110-3120 are run for each working affected object unless a validation error is encountered. For each working affected object, first, a materialized new version of the working affected object is generated by executing a JDV construction query. (3110) The JDV construction query is executed in consistent read mode.

A materialized old version of the working affected object is generated by executing a JDV construction query. (3115) The JDV construction query is executed in flashback mode.

The set of working affected directives of the duality view to which the working affected object belongs is evaluated. (3120) If a validation error is encountered by an evaluation of a working affected directive, an exception error is thrown, and then, the set of affected objects is unlocked.

If, after applying the respective working affected validation directives to all the working affected objects in the set of working affected objects, no validation error is encountered, then the set of affected objects is unlocked.

For validation performed for AFTER STATEMENT, validation directives may be applied without locking working affected objects or transactions when performing the object serialization algorithm. Transactional consistency is not assured, but the overhead of locking affected objects and transactions is avoided.

To ensure transactional consistency for validation performed for AFTER STATEMENT, the procedure depicted in FIG. 31 is performed by locking the set of working affected objects and transactions when performing the object serialization algorithm. The procedure is performed after the DBMS makes all the database modifications specified by the database statement, but before returning to the database client. Each database statement executed by a database transaction is associated with its own statement affected validation directives, if any, and hence, with its own working validation directives.

The working affected objects for each statement may differ between database statements. As mentioned before, the working table-key set tracks primary keys used to form affected-object queries that are used to generate sets of working affected objects. For validation performed AFTER STATEMENT for a database statement, only the primary keys of entries in the working table-key set that include the ID of the database statement are used to form affect-object queries.

### WRITE AUGMENTATION

As mentioned before, an augmentation may be defined as a write augmentation by specifying INSERT or UPDATE as the type of DML statement for which the augmentation is applied. In an embodiment, write augmentation may only set values of intrinsic fields, which are mapped to base columns. In another embodiment, write augmentation may set values for JSON fields referred to as flex fields. A flex field is not mapped to a base column. Flex fields shall be later described.

An important use of write augmentation is to modify field values (e.g., translate to upper case) or to set a default value for an intrinsic field, thereby setting a default value for the respective base column. The default value is computed according to a JSON expression specified by the write augmentation. The expression may be based on values from other fields of the JDV object, including augmented fields. When the intrinsic field values of the JDV object are written to the respective base row, the respective base column of the intrinsic field is set to the value of the intrinsic field.

In addition, write augmentations are only applied for DML statements that specify object-directed changes. Before describing write augmentations in further detail, it is useful to explain object-directed changes in further detail.

### OBJECT-DIRECTED CHANGES

There are several forms of object-directed changes: piecewise changes or overwrite changes. A DML command specifying a piecewise change specifies to change specific fields in a JSON object using JSON expressions. Database statements JQB and JQC, described above, are examples of DML statements that specify piecewise changes using an UPDATE statement that references a JSON_TRANSFORM function.

An example of a DML statement specifying an overwrite change is JDF below:
JDF=UPDATE CUST_OV SET DATA={“CustId”: “
   “CustName”: “A1 Cleaners”
   “CustEmail”:
   info@alcleaners.com”}
   WHERE CUST_OV.custID=‘47’

JDF specifies to overwrite the JDV object in CUST_OV having CustID=47 with the literal JSON object emboldened in JDF.

To execute a piecewise change, an in-memory JDV object to which to apply the piecewise changes is generated by the DBMS using object construction for each JDV object being changed by a DML statement. The in-memory JDV object is referred to herein as the staging object. As mentioned before, read augmentation is performed as part of object construction. Next, applicable validation directives having a BEFORE OBJECT application directive time may be applied to the staging object. After applying any validation directives, piecewise change operations are performed on the staging object, such as those that are specified in a JSON_transform function.

Write augmentations are then applied to the stage object. Write augmentations are then followed by application of validation directives, having the AFTER OBJECT application directive time may be applied.

At this stage, the staging object includes all the JSON field changes, including those made by write augmentation, that will be translated into changes to the respective one or more base rows and columns. Because the staging object includes all the changes that need to be translated, the staging object is referred to as the finalized staging object. Techniques for determining one or more base rows and columns that need to be changed and changing the one or more base rows and columns are described in the Json Duality View application and are referred to herein as base row reduction. Base row reduction begins with an operation referred to as object disassembly. Object disassembly, in effect, reverse engineers a JDV object, such as a staging object, into a logical set of base rows. This logical set is used by a subsequent operation that determines which one or more base rows and columns to change.

For an overwrite change, the JDV object with which to overwrite is provided by the user in the DML statement. In effect, the staging object is provided by the database client. Read augmentations are not applied by the DBMS. However, the staging object may include augmented fields that the database client provides. BEFORE OBJECT validations, write augmentations, and AFTER OBJECT validations are applied in the same way to the staging object, generate the input staging object.

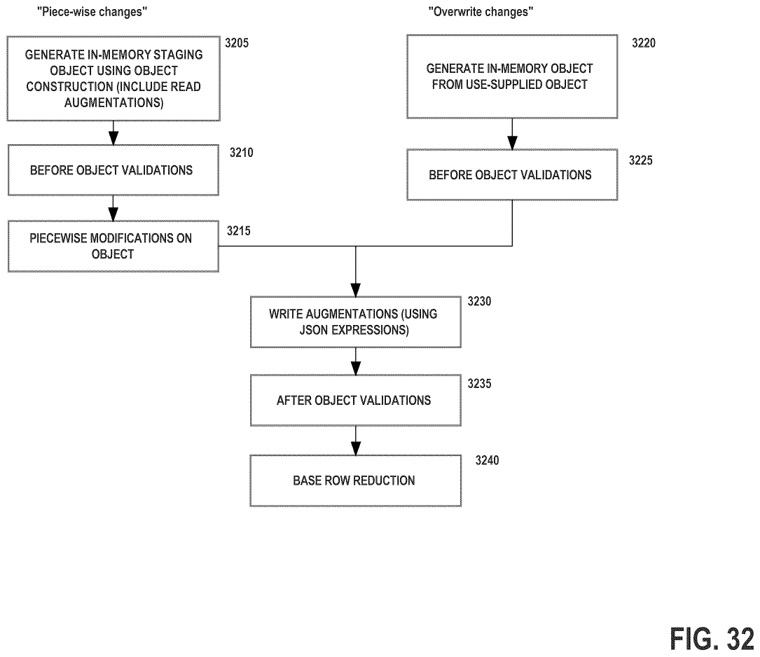

FIG. 32 is a diagram depicting several ways of performing object-directed changes that include write augmentation as previously described. For piecewise changes, the DBMS generates a staging object to be changed using object construction. (3205) This includes applying read augmentations. BEFORE OBJECT validations, if any, are performed. (3210) Next, piecewise changes are made to the in-memory JDV object. (3215)

Write augmentations are made to the staging object (3230), followed by applying AFTER OBJECT validations, resulting in the finalized staging object. (3230) Using the finalized staging object as input, base row reduction is performed. (3235)

For overwrite changes, the staging object is provided by the database client. (3220) Without having performed read augmentation, BEFORE OBJECT validations are performed. Finally, write augmentations (3230), AFTER OBJECT validations (3235), and base row reduction (3240) are performed as previously described for piecewise changes.

### INLINE WRITE AUGMENTATIONS

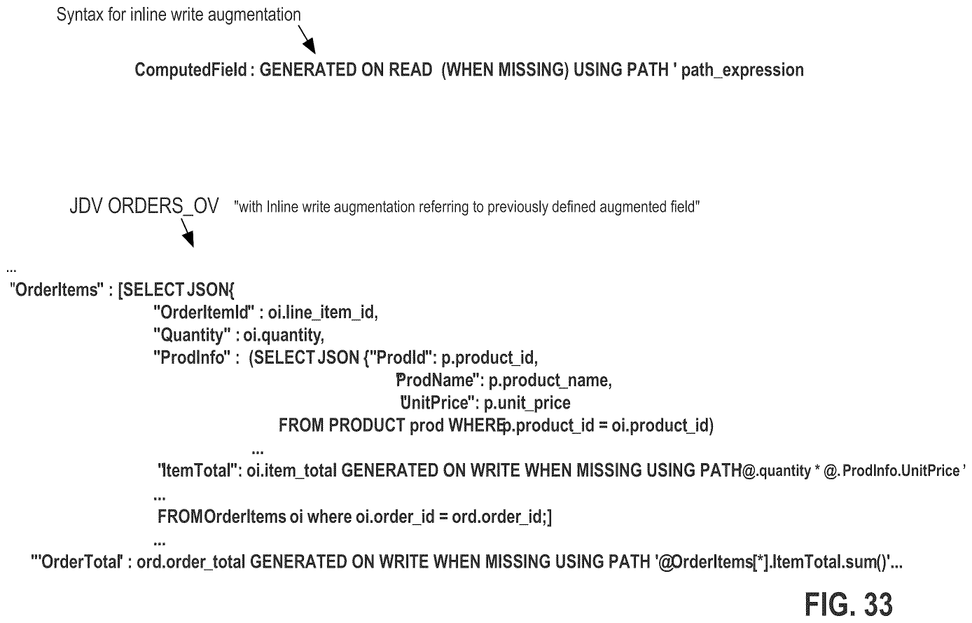

FIG. 33 depicts an illustrative syntax for an inline write augmentation. The argument ComputedField, which specifies the name of the augmented field, is followed by a GENERATED clause that includes an ON WRITE clause.

The inline write augmentation must define how to calculate the respective augmented field. The calculation is specified in the USING clause, which includes a PATH clause followed by the argument path_expr. The argument path_expr is a JSON path expression that is evaluated against a staging object.

To illustrate how inline write augmentations are applied, FIG. 33 also depicts a version of ORDERS_OV that defines two additional fields augmented by inline write augmentation, which are based on two additional base columns defined for ORDERS that are introduced here for purposes of illustration.

ORDERS_OV defines the intrinsic field ItemTotal for an array OrderItems. The base column for ItemTotal is item_total in ORDER_ITEMS. Also defined is the intrinsic field OrderTotal, the base column for which is column order_total in ORDERS.

The declaration of ItemTotal comprises an inline write augmentation that includes a WHEN MISSING clause. Hence, ItemTotal is only write augmented in a staging object that includes no value for the field ItemTotal. The write augmented value is calculated according to the JSON path expression @.quantity*@.ProdInfo.UnitPrice. The JSON field ItemPrice is defined as a JSON field of the OrderItems array field.

The declaration of ItemTotal comprises an inline write augmentation that includes a WHEN MISSING clause. Hence, ItemTotal is write augmented in a staging object that includes no value for the field ItemTotal. The write augmented value [defined] is calculated according to the JSON path expression @.quantity*@.ProdInfo.UnitPrice. The JSON field ItemPrice is defined as a JSON field of the OrderItems array field.

The declaration of OrderTotal comprises an inline write augmentation that also includes a WHEN MISSING clause. Hence, OrderTotal is only write augmented in a staging object that includes no value for the field OrderTotal. The write augmented value is calculated by the path expression @.OrderItems[*].ItemTotal.sum. The path expression returns the sum of ItemTotal across the elements of the OrderItems array.

The calculation of the write augmentation for OrderTotal uses the output of the write augmentation for ItemTotal in the OrderItem array. This relationship is an example of calculation dependency. The order in which the write augmentations for a stage object are calculated and applied is referred to as the run order. In general, the run order is consistent with calculation dependency among write augmentations for the JDV object. When calculation dependency can not be determined, other factors may be used to determine a run order. For example, write augmentations for fields at a deeper nesting level of the JDV object are calculated first. In an embodiment, an inline write augmentation may include a clause with an argument that specifies run order relative to other write augmentations.

### DEFAULT VALUE BY WRITE AUGMENTATION—EXAMPLES

As mentioned before, an important use of write augmentation is to generate default values not only for JDV object fields but also for the respective base columns in base tables. Generating such default values is described through examples. These examples are based on the duality view EMP_V defined based on a table EMPLOYEE, the columns for which are introduced in the description of the examples. EMPLOYEE is referred to by the alias “emp”.

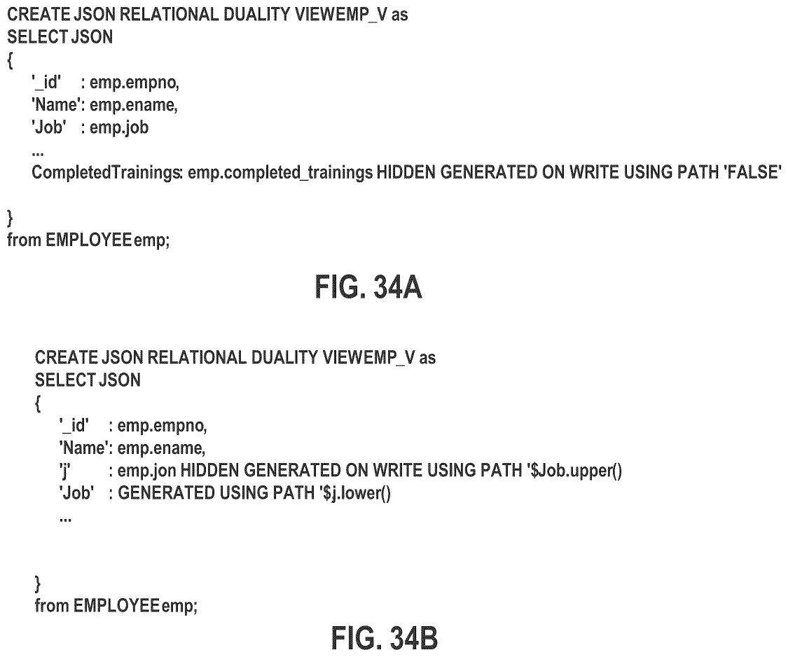

FIG. 34A depicts a version of EMP_V. Among the fields defined for EMP_V are _id, Name, and Job, the respective columns of which in EMPLOYEE are empno, ename, and job.

An employee record for a new employee may be inserted into EMPLOYEE by an object-directed insert into EMP_V of a client-provided JDV object. EMPLOYEE includes a column completed_trainings, which should be set to FALSE for a newly inserted employee record.

It is a design requirement that a client-supplied JDV object should not furnish a value for completed_training by including an intrinsic JSON field for the completed_training. However, it is a design requirement to populate completed_training whenever a JDV object is inserted into EMP_V.

To meet these requirements, EMP_V maps completed_trainings to a hidden field named CompletedTrainings. Hidden JSON fields defined for a duality view are not included in the JDV object returned to the client from the duality view. If a client-supplied JDV object includes a hidden field, the client-supplied value for the hidden field is ignored during base row resolution. However, a hidden field may be added or updated in interim generated JDV objects, such as a staging object, which may be used by JSON path expressions used to define the calculation of read augmentations and write augmentations. The clause HIDDEN in the declaration of EMP_V (see FIG. 34A) defines CompletedTrainings as a hidden field.

If a write augmentation augments a hidden field, the base column mapped to the hidden field is updated to the augmented values. Base row resolution processes the write augmented HIDDEN field by updating or inserting the respective base column accordingly. The inline write augmentation declared for CompletedTraining sets the field's value to FALSE, thereby setting the base column completed_training to a default value of FALSE.

Write augmentation may be used to generate default values for a field based on one or more other fields. FIG. 34B shows a version of EMP_V that illustrates the use of write augmentation for the purpose.

Referring to FIG. 34B, EMP_V defines a read augmented field JOB and a hidden field J. Hidden field J is an intrinsic field mapped to emp.job.

It is a design requirement that string values for emp.job be stored as upper case, but that JSON field Job in a JDV object of EMP_V be in lower case. Client-supplied JDV object may provide a value for Job in lower case.

The read augmentation for Job converts the string value in the hidden field J to lower case. The write augmentation for J converts the string value in JOB to upper case. Thus, when a client-supplied JDV object includes a string value in field JOB in lower case, the string value is converted by write augmentation to upper case. Thus, inserts or updates to respective base column emp.job include upper case string values.

### DYNAMIC COLUMNS

A dynamic column mechanism enables new columns to be dynamically created and stored in a database merely in response to the receipt of DML (“Data Manipulation Language”) SQL statements that reference the columns. The columns, when referenced by the received DML statements, are not defined as a column or attribute of a table by an explicit schema of the database. Such columns are referred to as dynamic columns. Dynamic columns are described in U.S. Patent Publication 2021-0224287A1 (Ser. No. 16/744,834) entitled Flexible Schema Tables, filed on Jan. 15, 2020, the entire contents are incorporated herein by reference.

Dynamic columns of a table are stored in an invisible column of the table that is referred to as an invisible-container column. A dynamic column and its column values are stored as key-value pairs in the invisible-container column. The key may be the dynamic column name.

To create dynamic columns for a table, the table is first enabled for dynamic columns. A table enabled for dynamic columns is referred to as a dynamic schema table. A dynamic schema table has one or more defined columns and an invisible-container column created in response to being enabled for dynamic columns. When a DML statement, such as an INSERT statement, is received by a DBMS, and the DML statement references a column that is not defined for a dynamic schema table or any other table in the INSERT statement, the column is added to the invisible-container column as a key-value pair.

Dynamic columns referenced in SQL statements may be treated in similar ways to defined columns. For example, when a DBMS executes a query statement that references a column of a dynamic schema table, and the column is not defined in the explicit schema for the table, the DBMS extracts the column from the invisible-container column and returns column values for the column, if any.

### FLEX FIELDS

According to an embodiment, a duality view may map to a JSON field to a dynamic column in a dynamic schema table. In general, when a DBMS receives a DDL statement defining a duality view, the DBMS runs validation checks. Among these checks is a check to ensure that the explicit schema of the respective base table defines a base column declared for a JSON field. However, if the base table of the column being mapped to a field is a dynamic schema table, and the explicit schema does not define the declared base column, then the DBMS treats the JSON field as being mapped to a dynamic column. Such a field is referred to herein as a flexible field or simply a flex field. The DBMS marks the flex field as such within the metadata defining the JSON field.

During base row resolution, a field in the staging object that is not an intrinsic field is ignored. A field that is not an intrinsic field does not cause an insert or update to a base column because there is no base column to modify. However, if the JSON field is marked as a flex field, then the DBMS stores the flex field as a key-value pair in the invisible-container column of the respective base table.

During object construction, the DBMS retrieves the value of a flex field from the corresponding key-value pair, if any, in the invisible-container column of the respective base table. If there is no such key-value pair, NULL is returned as the value for the flex field.

### DBMS OVERVIEW

A database management system (DBMS) manages a database. A DBMS may comprise one or more database servers. A database comprises database data and a database dictionary that is stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically-marked data objects; however, the hierarchically-marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

A database command may also be in the form of an API call. The call may include arguments that each specifies a respective parameter of the database command. The parameter may specify an operation, condition, and target that may be specified in a database statement. A parameter may specify, for example, a column, field, or attribute to project, group, aggregate, or define in a database object.

In a DOCS, a database command may be in the form of functions or object method calls that invoke CRUD (Create Read Update Delete) operations. Create, update, and delete operations are analogous to insert, update, and delete operations in DBMSs that support SQL. An example of an API for such functions and method calls is MQL (MondoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snap-shot time of the query. The DBMS determines which undo records to apply to a data block based on the respective logical times associated with the undo records.

When operations are referred to herein as being performed at commit time or as being commit time operations, the operations are performed in response to a request to commit a database transaction. DML commands may be auto-committed, that is, are committed in a database session without receiving another command that explicitly requests to begin and/or commit a database transaction. For DML commands that are auto-committed, the request to execute the DML command is also a request to commit the changes made for the DML command.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables and other information.

A database server includes multiple database processes. Database processes run under the control of the database server (i.e. can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g. shared access to a set of disk drives and data blocks stored thereon. The nodes in a multi-node database system may be in the form of a group of computers (e.g. work stations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains definition metadata that defines properties of the database object. For example, definition metadata in a database dictionary defining a database table may specify the attribute names and data types of the attributes, and one or more files or portions thereof that store data for the table. Definition metadata in the database dictionary defining a procedure may specify a name of the procedure, the procedure's arguments, and the return data type, and the data types of the arguments and may include source code and a compiled version thereof.

A database dictionary is referred to by a DBMS to determine how to execute database commands submitted to a DBMS. Database commands can access or execute the database objects that are defined by the dictionary. Such database objects may be referred to herein as first-class citizens of the database. A first-class citizen is associated with a database object name, which can be referenced in database commands to identify the first-class citizen to DBMS. The database object name is mapped or otherwise associated with the database object. The DBMS refers to the definition metadata of the first-class citizen to determine how to access or execute the first-class citizen.

A database object may be defined by the database dictionary, but the definition metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e. .java file) and the compiled version of the class (i.e. .class file).

Native data types are data types supported by a DBMS “out-of-the-box”. Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as a valid data types and to be processed by a DBMS in database statements. In general, database software of a DBMS is programmed to recognize and process native data types without configuring the DBMS to do so by, for example, defining a data type by issuing DDL statements to the DBMS.

### QUERY OPTIMIZATION AND EXECUTION PLANS

Query optimization generates one or more different candidate execution plans for a query, which are evaluated by a DBMS to determine which execution plan should be used to compute the query.

Execution plans may be represented by a graph of interlinked nodes, referred to herein as operators or row sources, that each corresponds to a step of an execution plan, referred to herein as an execution plan operation. The hierarchy of the graphs (i.e., directed tree) represents the order in which the execution plan operations are performed and how data flows between each of the execution plan operations. An execution plan operator generates a set of rows (which may be referred to as a table) as output. Execution of an execution plan operator by a DBMS performs operations such as a table scan and row filtering, an index scan, a sort-merge join, a nested-loop join, filtering, and a full outer join.

A query optimization may optimize a query by transforming the query. In general, transforming a query involves rewriting a query into another semantically equivalent query that should produce the same result and that can potentially be executed more efficiently, i.e., one for which a potentially more efficient and less costly execution plan can be generated. Examples of query transformation include view merging, subquery unnesting, predicate move-around and pushdown, common subexpression elimination, outer-to-inner join conversion, materialized view rewrite, and star transformation.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
a DBMS executing a database command that projects a JDV object from a JSON duality view, said JSON duality view defining an object schema for said JDV object, wherein said JSON duality view maps base columns of a plurality base tables to a plurality of intrinsic fields of said object schema;
wherein executing said database command includes generating said JDV object, where generating said JDV object includes:
generating said plurality of intrinsic fields of said object schema;
generating one or more augmented fields that are each an intrinsic field mapped to a base column;
wherein generating said JDV object includes:
retrieving a plurality of base rows for said JDV object based on said JSON duality view;
populating said plurality of intrinsic fields based on base columns of said plurality of base rows; and
computing respective value for each of said one or more augmented fields;
adding said one or more augmented fields to said JDV object;
after generating said JDV object, returning said JDV object with said one or more augmented fields as a result of said execution of said database command.

2. The method of claim 1, wherein an augmentation directive defines a particular augmented field of said one or more augmented fields, said augmentation directive specifying a field name for said augmented fields and how to compute said particular augmented field.

3. The method of claim 2, wherein said augmentation directive specifies a JSON expression for computing said particular augmented field.

4. The method of claim 3, wherein said JSON expression references an intrinsic field of said plurality of intrinsic fields.

5. The method of claim 3, wherein said JSON expression returns an aggregation of array field.

6. The method of claim 3, wherein said JSON expression references a second augmented field of said one or more augmented fields.

7. The method of claim 2, wherein said augmentation directive defines a function to invoke to add said one or more augmented fields to said JDV object.

8. The method of claim 7, wherein an implementation of said function adds said one or more augmented fields by invoking a method of an in-memory version of said JDV object.

9. The method of claim 1, wherein an inline augmentation of said JSON duality view defines a particular augmented field of said one or more augmented fields, said augmentation directive specifying a field name for said augmented fields and how to compute said augmentated field.

10. The method of claim 9, wherein said inline augmentation specifies a JSON expression for computing said particular augmented field.

11. The method of claim 10, wherein said JSON expression references an intrinsic field of said plurality of intrinsic fields.

12. The method of claim 9, wherein said inline augmentation defines a field value for said particular augmented fields that is the result of correlated subquery within a constructor query of said JSON duality view.

13. The method of claim 9, wherein said inline augmentation defines a field value for said particular augmented field that is the result of a correlated subquery within a constructor query defined by said JSON duality view.

14. The method of claim 1, wherein an augmentation directive defines an expression that returns a value to which to set an intrinsic field.

15. The method of claim 1, wherein:
a write augmentation defines an expression to which to set a first intrinsic field of said plurality of intrinsic fields;
the method further includes:
receiving a DML statement that:
is object-directed to said JDV object;
specifies a change to a second intrinsic field of said plurality of intrinsic fields; and
does not specify a change to said first intrinsic field; and
in response to receiving said DML statement:
applying said write augmentation to set said first intrinsic field to the result of the expression; and
setting a respective base column value of said first intrinsic field to said result of the expression.

16. The method of claim 15, wherein said JSON duality view includes said write augmentation as an inline write augmentation.

17. The method of claim 1, wherein said JSON duality view maps a particular JSON field to a dynamic column of a base table of said plurality of base tables, where said DBMS does not explicitly define said dynamic column.

18. The method of claim 17, wherein:
a write augmentation defines an expression to which to set said particular JSON field;
the method further includes:
receiving a DML statement that specifies a change to said particular JSON field;
in response to receiving said DML statement:
applying said write augmentation to set said particular JSON field to a write augmentation value; and
setting said dynamic column in a base row to said write augmentation value as a key-value pair.

19. One or more non-transitory storage media storing one or more sequences of instructions which, when executed by one or more computing devices, cause:
a DBMS executing a database command that projects a JDV object from a JSON duality view, said JSON duality view defining an object schema for said JDV object, wherein said JSON duality view maps base columns of a plurality base tables to a plurality of intrinsic fields of said object schema;
wherein executing said database command includes generating said JDV object, where generating said JDV object includes:
generating said plurality of intrinsic fields of said object schema;
generating one or more augmented fields that are each an intrinsic field mapped to a base column;
wherein generating said JDV object includes:
retrieving a plurality of base rows for said JDV object based on said JSON duality view;
populating said plurality of intrinsic fields based on base columns of said plurality of base rows; and
computing respective value for each of said one or more augmented fields;
adding said one or more augmented fields to said JDV object;
after generating said JDV object, returning said JDV object with said one or more augmented fields as a result of said execution of said database command.

20. The one or more non-transitory storage media of claim 19, wherein an augmentation directive defines a particular augmented field of said one or more augmented fields, said augmentation directive specifying a field name for said augmented fields and how to compute said particular augmented field.
